(19) United States
(12) Patent Application Publication
(10) Pub. No.: US 2025/0094733 A1
(43) Pub. Date: Mar. 20, 2025

(54) DIGITAL ASSISTANT USING GENERATIVE ARTIFICIAL INTELLIGENCE

(71) Applicant: Oracle International Corporation, Redwood Shores, CA (US)

(72) Inventors: Xin Xu, San Jose, CA (US); Vishal Vishnoi, Redwood City, CA (US); Srinivasa Phani Kumar Gadde, Fremont, CA (US); Ying Xu, Albion (AU); Diego Andres Cornejo Barra, Chicago, IL (US); Raman Grover, Charlotte, NC (US); Stephen Andrew McRitchie, Palo Alto, CA (US)

(73) Assignee: Oracle International Corporation, Redwood Shores, CA (US)

(21) Appl. No.: 18/798,049

(22) Filed: Aug. 8, 2024

Related U.S. Application Data
(60) Provisional application No. 63/583,225, filed on Sep. 15, 2023.
(60) Provisional application No. 63/583,022, filed on Sep. 15, 2023.

(51) Int. Cl. G06F 40/40

(52) U.S. Cl. CPC G06F 40/40

(57) ABSTRACT

Techniques are disclosed herein for configuring agents for use by digital assistants that use generative artificial intelligence. An agent may be in the form of a container that is configured to have one or more actions that can be executed by a digital assistant. The agent may be configured by initially defining specification parameters for the agent based on natural language input from a user. Configuration information for the one or more assets can be imported into the agent. One or more actions may then be defined for the agent based on importing of the configuration information, the natural language input from the user, or both. A specification document can be generated for the agent and can comprise various description metadata, such as agent, asset, or action metadata, or combinations thereof. The specification document may be stored in a data store that is communicatively coupled to the digital assistant.

### CROSS-REFERENCE TO RELATED APPLICATIONS

The present application is a non-provisional application of and claims the benefit and priority under 35 U.S.C. 119(e) of U.S. Provisional Application No. 63/583,225, filed on Sep. 15, 2023, and U.S. Provisional Application No. 63/583,022, filed on Sep. 15, 2023, both of which are herein incorporated by reference in their entireties for all purposes.

### FIELD

The present disclosure relates generally to digital assistants, and more particularly, to techniques for implementing digital assistants using generative artificial intelligence techniques such as those involving large language models.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method is provided that can be used to implement digital assistants using generative artificial intelligence. The computer-implemented method can comprise accessing a container defining an agent configurable to have one or more actions; and configuring the agent for use by a digital assistant, wherein the configuring comprises defining, based on natural language input from a user, specification parameters including an identification of the agent, a purpose of the agent, and identification of one or more assets for implementing the purpose, defining configuration information for the one or more assets, and defining the one or more actions based on the configuration information, the natural language input from the user, or both. The computer-implemented method can further comprise generating a specification document that characterizes the agent, wherein generating the specification document comprises: acquiring, from the agent, metadata associated with the specification parameters, the one or more assets, the one or more actions, or any combination thereof, and writing the specification document to include the metadata and the identification of the agent; and storing the specification document in a data store that is communicatively coupled to a digital assistant.

In some embodiments, a natural language utterance from the user is received by a generative artificial intelligence model and used to test the functionality of the agent to implement the purpose of the agent.

In some embodiments, the testing by the prompt-based agent composition tool is an interactive process between the user and the generative artificial intelligence model and comprises (i) evaluating the natural language utterance based on the specification document; (ii) selecting the agent for use in responding to the natural language utterance based on evaluating the natural language utterance; (iii) generating an execution plan comprising the one or more actions defined for the agent; (iv) executing, based on the execution plan and the configuration information for the one or more assets, the one or more actions to obtain output data; (v) generating a response to the natural language utterance based on the output data; and (vi) evaluating, based on the response, the functionality of the agent to implement the purpose of the agent.

In some embodiments, the interactive testing process further comprises (vii) determining, based on evaluating the purpose of the agent, the functionality of the agent to implement the purpose of the agent is unacceptable; (viii) in response to determining the functionality is unacceptable, receiving additional natural language input from the user concerning a change to the specification parameters; (ix) reconfiguring the agent based on the change to the specification parameters; and (x) reperforming steps (i)-(vi) of the interactive process.

In some embodiments, defining the configuration information for the one or more assets comprises accessing a specification for each of the one or more assets; extracting the configuration information from the specification for each of the one or more assets; and writing the configuration information into the container.

In some embodiments, the computer-implemented method further comprises receiving a natural language utterance as a user input to the digital assistant; and generating a response to the natural language utterance based on the specification document and the agent.

In some embodiments, generating the response to the natural language utterance comprises executing, using the natural language utterance, a search on specification documents in the data store, wherein the specification documents include the specification document for the agent; identifying, based on the search, one or more candidate agents and associated actions for generating the response, wherein the one or more candidate agents include the agent; generating an input prompt by combining metadata obtained from specification documents for the one or more candidate agents with the natural language utterance, wherein the metadata comprises the metadata written in the specification document for the agent; generating, by a first generative artificial intelligence model and based on the input prompt, an execution plan for responding to the natural language utterance, wherein the execution plan includes an order list of actions comprising the one or more actions; executing, based on the execution plan and the configuration information for the one or more assets, the one or more actions to obtain output data; generating, using the output data, an output prompt for a second generative artificial intelligence model of the digital assistant, the second generative artificial intelligence model being the same or different from the first generative artificial intelligence model; and generating, by the second generative artificial intelligence model and based on the output prompt, the response to the natural language utterance.

In various embodiments, a system is provided and can be used to implement digital assistants using generative artificial intelligence. The system can include one or more processors and one or more computer-readable media storing instructions which, when executed by the one or more processors, can cause the system to perform part or all of the operations and/or methods disclosed herein.

In various embodiments, one or more non-transitory computer-readable media are provided and can be used to implement digital assistants using generative artificial intelligence. The one or more non-transitory computer-readable media can store instructions which, when executed by one or more processors, can cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a digital assistant system in accordance with various embodiments.

FIG. 2 is an example of a user interface for configuring an agent of a digital assistant in accordance with various embodiments.

FIGS. 3-4 collectively depict a mock conversation between a user and a simulated agent during use of an LLM-based agent composition tool to create and configure an agent in accordance with various embodiments.

FIG. 5 is a mock conversation between a simulated end-user and a simulated digital assistant that uses the agent created and configured according to the LLM-based agent creation and configuration process of FIGS. 2-3 in accordance with various embodiments.

FIG. 6 is another mock conversation between a simulated end-user and a simulated digital assistant that uses the agent created and configured according to the LLM-based agent creation and configuration process of FIGS. 2-3 in accordance with various embodiments.

FIG. 7 depicts a mock conversation between a user and an LLM-based agent composition tool during use of the LLM-based agent composition tool to create a digital assistant and agent artifacts in accordance with various embodiments.

FIG. 8 depicts a mock conversation between a user and an LLM-based agent composition tool during use of the LLM-based agent composition tool to create top-level agent metadata in accordance with various embodiments.

FIG. 9 depicts a mock conversation between a user and an LLM-based agent composition tool during use of the LLM-based agent composition tool to actions metadata for an agent in accordance with various embodiments.

FIG. 10 depicts a mock conversation between a user and an LLM-based digital assistant builder platform during use of the digital assistant builder platform to create a digital assistant in accordance with various embodiments.

FIG. 11 is an example of a computing environment involving a digital assistant that can be implemented with generative artificial intelligence in accordance with various embodiments.

FIG. 12 is a flowchart of a process for configuring an agent in accordance with various embodiments.

FIG. 13 is a flowchart of a process for testing a configured agent in accordance with various embodiments.

FIG. 14 is a flowchart of a process for generating a response to user input using a digital assistant that can be implemented using generative artificial intelligence in according with various embodiments.

FIG. 15 depicts a simplified diagram of a distributed system for implementing various embodiments.

FIG. 16 is a simplified block diagram of one or more components of a system environment by which services provided by one or more components of an embodiment system may be offered as cloud services, in accordance with various embodiments.

FIG. 17 illustrates an example computer system that may be used to implement various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Artificial intelligence techniques have broad applicability. For example, a digital assistant can be or include an artificial-intelligence-driven interface that helps users accomplish a variety of tasks using natural language conversations. For conventional digital assistants, such as those that do not involve generative artificial intelligence, a provider of the digital assistant may assemble one or more skills that can be focused on specific types of tasks such as tracking inventory, submitting timecards, and creating expense reports. When an end user engages with the digital assistant, the digital assistant can evaluate input provided by the end user to determine the intent of the end user and can route the conversation to and from the appropriate skill based on a perceived intent of the end user. However, there are some disadvantages of traditional intent-based skills including a limited understanding of natural language, inability to handle unknown inputs, limited ability to hold natural conversations off script, challenges integrating external knowledge, and the like.

User interactions with a digital assistant can lead to prompt responses to queries or the execution of requested actions. Additionally, these interactions have the potential to emulate human-like conversations, resembling a natural back-and-forth dialogue between a user and a human operator. To enhance user experience, digital assistants may also engage in multimodal communications, allowing users to convey information through spoken utterances or alternative input methods, such as selecting options on a computer display. However, achieving such functionalities efficiently with digital assistants, especially through natural language models, poses several challenges. For instance, understanding human speech remains a significant hurdle for natural language models, even those based on machine-learning. The scalability of the models can be problematic and inefficient, while their domain-specific limitations further complicate effective communication in various contexts.

The advent of generative artificial intelligence techniques and models, such as large language models (LLMs), has propelled the field of digital assistant design to unprecedented levels of sophistication and can be used to address the above and other technical problems associated with traditional intent-based skills. An LLM can be or include a neural network that employs a transformer architecture, which is specifically generated for processing and generating sequential data such as text or words in conversations. LLMs can undergo training with extensive textual data, and the training can gradually hone an ability to generate text that closely mimics human-written or spoken language. While LLMs excel at predicting the next word in a sequence, it's important to note that their output isn't guaranteed to be entirely accurate. Their text generation relies on learned patterns and information from training data, which could be incomplete, erroneous, or outdated, as their knowledge is confined to their training dataset. LLMs don't possess the capability to recall facts from memory; instead, the focus of the LLM is on generating text that appears contextually appropriate.

To address this limitation and others, techniques are described herein to enhance LLMs with tools that empower or otherwise provide the LLMs access to external knowledge sources that provide the LLMs with the capability to recall facts and/or knowledge and facilitate the LLMs to better understand and respond to user queries in a contextually relevant manner. These tools, referred to herein as “agents,” provide the LLMs with the capability to recall facts and/or knowledge utilizing various techniques such as knowledge graphs, custom knowledge bases, Application Programming Interfaces (APIs), web crawling or scraping, and the like. Once configured, the LLMs and agents can be deployed in artificial intelligence-based systems such as digital assistant applications. Users, such as end users or other entities, can interact with the digital assistant, such as by posing questions or making requests, and the LLMs and agents can work in tandem to generate responses based on a combination of a base LLM capability and access to the external knowledge that can be provided by or to which the LLM can be directed via the agent. Using the LLMs and agents allows the digital assistant to provide more accurate, relevant, and contextually appropriate responses across a wide range of applications and domains.

For each digital assistant, a user (e.g., developer) may assemble LLMs and agents that interact to provide human-like conversation capabilities for various types of tasks such as tracking inventory, submitting timecards, updating accounts, creating expense reports, and the like. The LLMs are machine learning models trained for various tasks including plan creation using the LLM's in-context learning capability, knowledge or information retrieval on behalf of an agent, response generation to facilitate the human-like conversation, or any combination thereof. In one example, an agent may be defined by a container and may be configured to have one or more actions. The container may include various information/data that can be used to define the agent, including the agent purpose, the agent actions, etc. For example, an agent may be a container of information defining various agent actions that can be executed by a digital assistant to respond to user queries. A single agent can be associated with and can be used by more than one digital assistant and more than one LLM utilized by the one or more digital assistants. In another example, an agent may be encapsulated within a container image, and the container image may include everything needed to execute one or more actions defined for the agent. For example, the container image may include the code and any runtime configurations the code requires, a file system, application and system libraries, default values for any settings, and the like.

The configuration parameters, settings, and customizations for dialog and routing/reasoning are primarily defined using natural language by a user (e.g., a developer). For example, users can provide configuration parameters through which the agent can direct a digital assistant to external assets, such as APIs, knowledge-based assets such as documents, URLs, LLMs, images, etc., data stores, prior conversations, etc., for executing one or more actions (e.g., change a user's 401k contribution). Once an agent is created, flow confirmation and testing may be performed through simulated conversations between LLMs and agents, and a digital assistant can then be implemented.

Implementation of an LLM-based digital assistant generally involves receiving a user input, such as a verbal request, command, or other statement (e.g., an utterance) from which the LLM-based digital assistant has a high-level awareness of the goal of the end user. A list of candidate agents is then determined based on the user input. The list of candidate agents includes agents configured with information about one or more actions that may potentially facilitate a response by an associated digital assistant to the user input. Metadata for the agents in the list of candidate agents is then combined with the user input to generate an input prompt for an LLM. The LLM generates an execution plan that includes actions for facilitating a response to the user input based on the input prompt and metadata. The execution plan is then executed by an execution engine, which can execute the actions defined by the agents. The actions may include internal task mapping in which a given action can be mapped to an API or semantic search knowledge task type. The execution of the actions generates output data from various sources, such as knowledge, API, SQL operations, etc., and/or relevant context and memory information from a context and memory store. The output data and relevant context and memory information are then combined with the user input to generate an output prompt for an LLM. The LLM synthesizes a response to the user input based on the output data and relevant context and memory information, and user input. The response is then sent to the user as an individual response or as part of a conversation with the user.

In one particular aspect, a computer-implemented method is provided that comprises: accessing a container defining an agent configurable to have one or more actions; and configuring the agent for use by a digital assistant, wherein the configuring comprises defining, based on natural language input from a user, specification parameters including an identification of the agent, a purpose of the agent, and identification of one or more assets for implementing the purpose, defining configuration information for the one or more assets, and defining the one or more actions based on the configuration information, the natural language input from the user, or both. The computer-implemented method can further comprise generating a specification document that characterizes the agent, wherein generating the specification document comprises: acquiring, from the agent, metadata associated with the specification parameters, the one or more assets, the one or more actions, or any combination thereof, and writing the specification document to include the metadata and the identification of the agent; and storing the specification document in a data store that is communicatively coupled to a digital assistant.

Advantageously, the LLM-based digital assistant described herein leverages reasoning capabilities of LLMs to drive decision-making and action orchestration to recall facts and/or knowledge and to facilitate the LLMs to better understand and respond to user queries in a contextually relevant manner. Additionally, or alternatively, the LLM-based digital assistant can eliminate a need for scripted dialog flows and provide out-of-the-box, human-like conversation capabilities.

As used herein, when an action is “based on” something, this means the action can be based at least in part on at least a part of the something. As used herein, the terms “similarly,” “substantially,” “approximately,” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1 percent, 1 percent, 5 percent, and 10 percent, etc.

### LLM-Based Digital Assistant

A digital assistant can be or include a computer program that can perform conversations with end users. The digital assistant can generally respond to natural-language messages, such as questions and/or comments, through a messaging application (referred to herein as channels) that uses natural-language messages. The digital assistant can be made available to end users through a variety of channels, as well as via an application interface that may be developed to include a digital assistant, for example using a digital assistant software development kit. The channels may be or include an end-user-preferred messaging application that the end user has already installed and with which the end user may already be familiar. In some examples, the end user may not need to download and install new applications in order to converse with the digital assistant system. The channels may include, for example, over-the-top (OTT) messaging channels, such as Facebook™ Messenger, Facebook™ WhatsApp™, WeChat™, Line, Kik™, Telegram™, Talk, Skype™, Slack™, or SMS, virtual private assistants (such as Amazon™ Dot, Echo, or Show, Google™ Home, Apple™ HomePod™, etc.), mobile and web app extensions that extend native or hybrid/responsive mobile apps or web applications with chat capabilities, or voice based input such as devices or apps with interfaces that use Siri™, Cortana™, Google™ Voice, or other speech input for interaction.

The channels can carry the chat back and forth from end users to the digital assistant and various LLMs associated with the digital assistant. During the back-and-forth exchanges, the LLMs can receive the processed input in the form of a query and can process the query to generate a response. An LLM can predict the most contextually relevant and grammatically correct response based on training data used to train the LLM and based on received input such as the query and actions defined by the agents. The generated response may undergo post-processing to ensure adherence to guidelines, policies, and formatting standards associated with the digital assistant. This post-processed response may be more coherent and user-friendly than other responses that do not undergo post-processing. The post-processed response can be delivered to the user through the appropriate channel, which may be or include a text-based chat interface, a voice-based system, or another medium. According to various embodiments, the digital assistant can maintain the conversation context, allowing for further interactions and dynamic back-and-forth exchanges between the user and the LLMs where later interactions can build upon earlier interactions.

In some embodiments, the digital assistant system may intelligently handle end user interactions without interaction with a provider, such as an administrator or developer, of the digital assistant system. For example, an end user may send one or more messages to the digital assistant system in order to achieve a desired goal. A message may include certain content, such as text, emojis, audio, image, video, or other method of conveying a message. In some embodiments, the digital assistant system may convert the content into a standardized form, such as a representational state transfer (REST) or API call, against enterprise services with the proper parameters, and generate a natural language response. The digital assistant system may also prompt the end user for additional input parameters or request other additional information. In some embodiments, the digital assistant system may also initiate communication with the end user, rather than passively responding to end user utterances. Various techniques can be used for identifying an explicit invocation of a digital assistant system and determining an input for the digital assistant system being invoked. In certain embodiments, explicit invocation analysis can be performed by a master digital assistant based at least in part on detecting an invocation name in an utterance. In response to detecting the invocation name, the utterance may be refined or pre-processed for input to a digital assistant that is identified to be associated with the invocation name and/or communication.

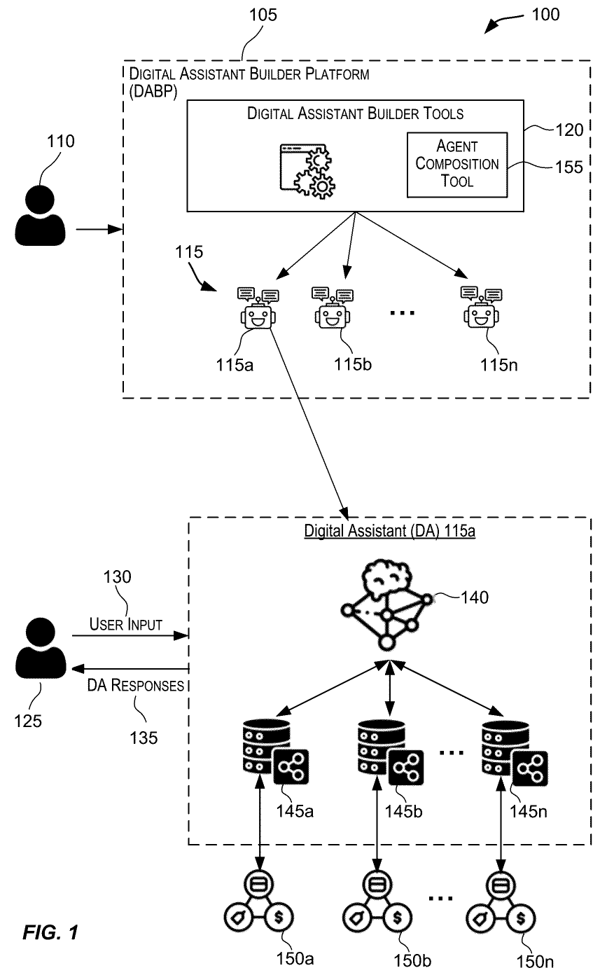

FIG. 1 is a simplified block diagram of an environment 100 incorporating a digital assistant system according to certain embodiments. Environment 100 includes a digital assistant builder platform (DABP) 105 that enables users 110 to create and deploy digital assistant systems 115. For purposes of this disclosure, a “digital assistant” is an entity that helps users of the digital assistant accomplish various tasks through natural language conversations. A digital assistant can be implemented using software only (e.g., the digital assistant is a digital entity implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

The DABP 105 can be used to create one or more digital assistants (or DAs). For example, as illustrated in FIG. 1, user 110 representing a particular enterprise can use the DABP 105 to create and deploy a digital assistant 115a for users of the particular enterprise. For example, the DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use the DABP 105 to create and deploy digital assistant 115b that enables customers of the restaurant to order food (e.g., order pizza).

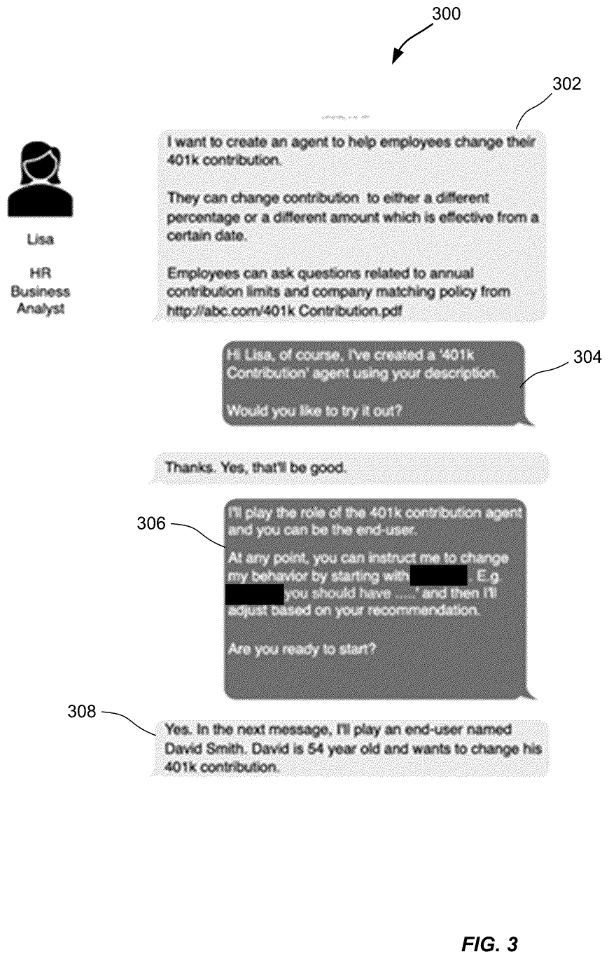

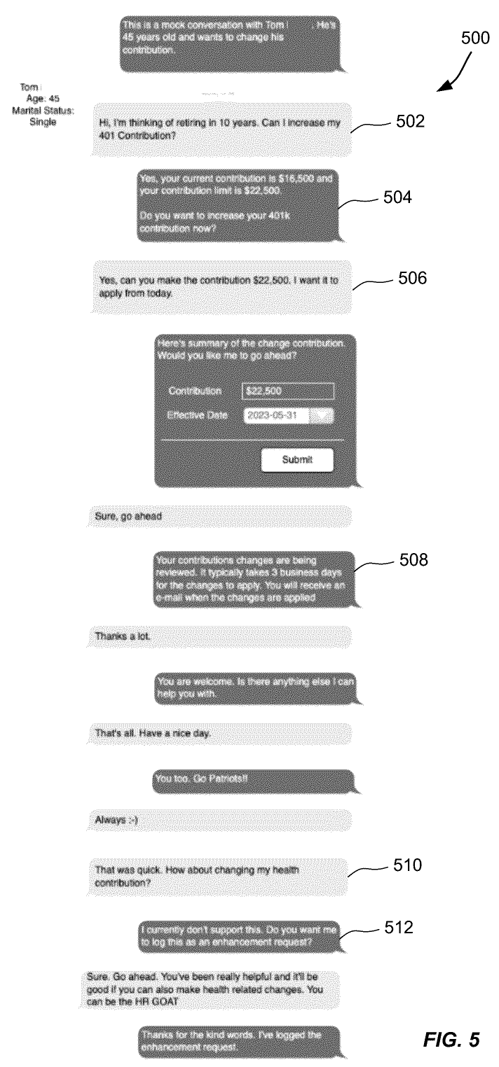

To create one or more digital assistant systems 115, the DABP 105 is equipped with a suite of tools 120, enabling the acquisition of LLMs, agent creation, asset identification, and deployment of digital assistant systems within a service architecture (described herein in detail with respect to FIG. 3) for users via a computing platform such as a cloud computing platform described in detail with respect to FIGS. 5-8. In some instances, the tools 120 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval from an agent or as directed by an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

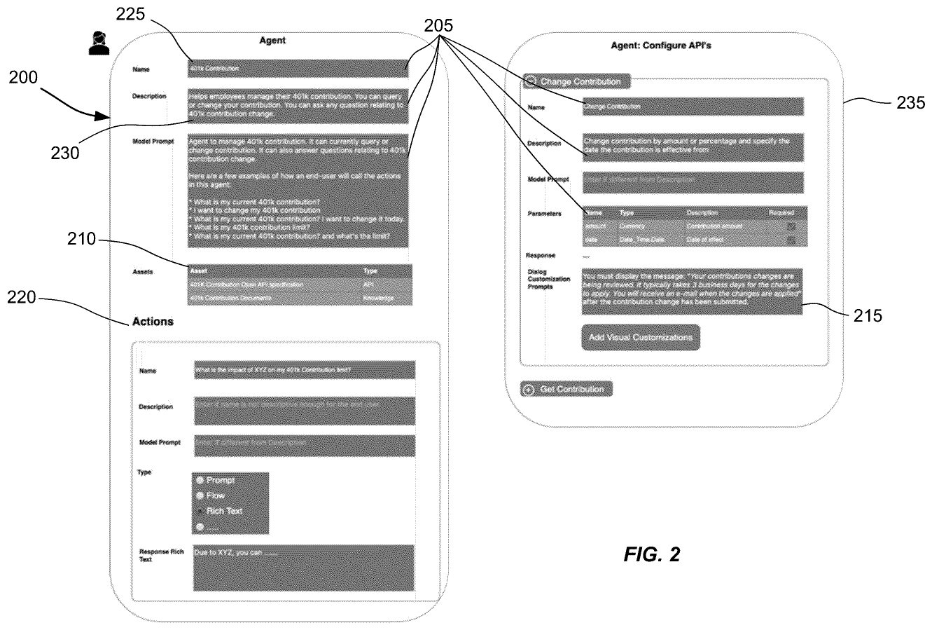

The tools 120 can further include an agent composition tool 155 for creating agents 145 and their associated actions (e.g., a prompt such as Tell me a joke, implicit Change Contribution, and Get Contribution API calls) that an end-user can ultimately invoke. The agent composition tool 155 may be a prompt-based tool. As further shown in FIG. 2, the agents 145 (e.g., 401k Change Contribution Agent 200) are primarily defined as a compilation of agent artifacts 205. Users 110 can create agents quickly by providing agent artifact 205 information, parameters, and configurations and by pointing to assets 210 using natural language within the prompt-based agent composition tool 155. The assets 210 may be resources such as API specifications for APIs through which a digital assistant can interface with applications. The assets 210 can also be files and/or documents for retrieving knowledge, data stores for interacting with data, and the like available to the digital assistant for the execution of actions. The assets 210 can then be imported and the users 110 can, if desired, further use natural language to provide additional API customizations for dialog and routing/reasoning 215.

As may be observed in FIG. 2, examples of the agent composition tool 155 may provide a user 110 with a user interface that can facilitate creation and configuration of agents 145. The user interface may be standardized to render the process of creating and configuring multiple agents 145 more efficient. In some examples, the same user interface may be provided regardless of the purpose of an agent 145. In other examples, the user interface may be unique to the agent purpose. For example, one user interface may be provided when the purpose of an agent 145 is 401k related and another user interface may be provided when the purpose of an agent 145 is item-ordering related. The user interface may include a number of fields that can accept natural language inputs from a user 110. For example, as illustrated in FIG. 2, a user interface can include fields via which a user 110 can identify/name an agent 145, enter a purpose for the agent 145, provide model prompt information for the agent 145, which may inform the agent of various ways a digital assistant or a component of a digital assistant might call actions defined in the agent, fields that can accept asset location and type information, and a plurality of fields by which the agent actions can be defined.

An agent may further include, or may have associated therewith, a number of different artefacts. For example, artefacts may include an agent action, agent action parameters, an agent action group, an agent assistant relation, an application event subscription, and application event property mapping. An agent action may be of a specific action type and may contain a description and a JSON schema that defines the action parameters. The action description and parameters schema may be semantically indexed, and can be sent, for example, to a planner LLM to select the appropriate action(s) to execute. In some examples, an action can optionally be part of an action group. An action group may be used, for example, when importing a plugin manifest, or when importing an Open API specification. An action group can be particularly useful when re-importing a plugin or an open API specification, as it can facilitate adding new actions, updating existing actions, or removing actions that are no longer present in a new plugin manifest or Open API specification. At runtime, an action group can be used to limit application context groups that may be sent to a LLM as conversation context, such as by looking up the action group name that corresponds to a context group context. An agent assistant relation may be thought of as an intersection entity that links an agent to a digital assistant. An application event subscription is a class that defines what agent action(s) should be executed when an application event is received. An application event may be received for example, in the form of a message that includes a command to update the application context. Application event property mapping may be a class by which event payload properties can be mapped to corresponding agent action parameters.

Natural language inputs may be typed into fields of the user interface in some examples. Some examples of the user interface may also allow a user 110 to populate the fields using natural language utterances. In other examples, an agent 145 can be created from scratch. For example, a user 110 may create an agent 145 by defining the purpose of the agent 145 and thereafter having a few mock conversations with the agent 145. The persistence, an API, etc., may then be automatically created for the agent 145, along with a user interface.

Each of the agent action, agent action parameters, agent action group, application event subscription, and application event property mapping artefacts may have a number of individual properties. Each property may be associated with a property type, and may be tagged (e.g., identified) as being required or not required. At least some of the individual properties may have default values.

Examples of agent action properties can include, for example, “name,” “type,” “description,” “parameters JSON Schema,” “parameters,” “slot filling mode,” “response type,” “generate response message,” “rest service,” “rest service method,” “event handler,” “thread ID,” and “settings In one example, the “name” property may be of a string type, may be defined as a required property, and can be usable to define the name of the action. In one example, the “type” property may be of an enumeration type, may be defined as a required property, and can be usable to define the type of the action group. Various action types are possible. For example, an action type may be an API call that calls a rest service method, a semantic action that sends a command to execute an application action message to a user interface, a flow action that invokes a custom visual flow, a custom component action that invokes a custom component, a knowledge action, or a prompt. In one example, the “description” property may be of a string type, may be defined as not being a required property, and can be usable to define a description of the action. In one example, the “parameters JSON Schema” property may be of a JSON object type, may be defined as not being a required property, and can be usable to define a JSON schema that defines the action parameters. In one example, the “parameters” property may be of a list type, may be defined as not being a required property, and can be usable to provide a list of parameters that is created based on the JSON schema. In one example, the “slot filling mode” property may be of an enumeration type, may be defined as a required property, may have a FORM default value, and can be usable to define mode by which a user is asked to provide missing required action parameters. For example, the mode may be a form mode wherein an editable form is displayed. The form may have all fields, both required and optional, that already have a value based on the user query and application context pre-filled. In another example, the mode may be a dialog mode wherein text message is displayed prompting the user for the missing required action parameters. In one example, the “response type” property may be of a list type, may be defined as a required property, may have a JSON default value, and can be usable to define the response type of the action. For example, the response type may be text, whereby the action returns plain text and the response engine may convert the plain text to a CMM text message which can sent to the digital assistant. In another example, the response type may be a JSON response type, whereby the action returns JSON. An event handler may be defined to convert a JSON response type to a CMM text message. In another example, the response type may be a CMM response type, whereby the action itself returns a CMM message which is sent to the digital assistant. In another example, the response type may be a CDA summary JSON response type, whereby the action returns a JSON in a CDA Clinical Summary Format. A dedicated converter may be used to convert this format into a CMM message and send it to the digital assistant. In one example, the “generate response message” property may be of a Boolean type, may be defined as a required property, may have a “true” default value, and can be usable to invoke an LLM to generate a confirmation message that is sent to the digital assistant to inform the user that the action has been executed successfully. In one example, the “rest service” property may be of a rest service type, may be defined as not being a required property, and can be usable to invoke an API. The “rest service” property may be applicable only when the action type is an API call. In one example, the “rest service method” property may be of a rest service method type, may be defined as not being a required property, and can be usable to invoke an API. The “rest service” property may be applicable only when the action type is an API call. In one example, the “event handler” property may be of a string type, may be defined as not being a required property, and can be usable to customize the action lifecycle. In one example, the “thread ID” property may be of a string type, may be defined as not being a required property, and can be usable by a planner to switch dialog threads when the user message triggers an action of type “plugin semantic action” that should be running in a different thread than the current thread. In one example, the “settings” property may be of a JSON Object type, may be defined as not being a required property, and can be usable to apply additional configuration settings. For example, the settings property may be usable to set other response generation options.

Examples of agent action parameter properties can include, for example, “name,” “type,” “description,” “required,” “default value,” “allowable values,” “display sequence,” “label,” “display type,” “multi value,” and “settings.” In one example, the “name” property may be of a string type, may be defined as a required property, and can be usable to define the name of the action parameter. In one example, the “type” property may be of an enumeration type, may be defined as a required property, and can be usable to define the type of the action parameter. The enumeration type may be, for example, string, integer, number, Boolean, object or array. In one example, the “description” property may be of a string type, may be defined as not being a required property, and can be usable to define a description of the action. In one example, the “required” property may be of a Boolean type, may be defined as being a required property, may have a “false” default value, and can be usable as a Flag that indicates whether the parameter must have a value before the action can be executed. In one example, the “default value” property may be of a string type, may be defined as not being a required property, and can be usable to define the default value of the parameter. In one example, the “allowable values” property may be of a list type, may be defined as not being a required property, and can be usable to provide a list of allowable values to which the parameter value should adhere. In one example, the “display sequence” property may be of an integer type, may be defined as a required property, and can be usable with an editable form or dialog to prompt for a missing parameter value. In one example, the “label” property may be of a string type, may be defined as a required property, and can be usable to define the parameter label that should be used during slot filling. In one example, the “display type” property may be of an enumeration type, may be defined as a required property, may have a “text input” default value, and can be usable to enhance a slot filling editable form, or a slot filling dialog. The enumeration may be, for example, text, a link, media, an action, a text input, a number input, a data picker, a time picker, a toggle, a single select, or a multi-select. In one example, the “multi value” property may be of a Boolean type, may be defined as a required property, may have a “false” default value, and can be usable to indicate whether the parameter is a multi-value parameter. The multi value property is applicable when the allowable values property is set. The multi value property may be used to generate a list of checkboxes instead of radio buttons in a slot filling editable form when the default value is set to “true.” In one example, the “settings” property may be of a JSON Object type, may be defined as not being a required property, and can be usable to apply additional configuration settings. For example, the settings property may be usable to set other response generation options.

Examples of agent action group properties can include, for example, “name,” “type,” “description,” “version,” and “actions.” In one example, the “name” property may be of a string type, may be defined as a required property, and can be usable to define the name of the action group. In one example, the “type” property may be of an enumeration type, may be defined as a required property, and can be usable to define the type of the action group. In one example, the “description” property may be of a string type, may be defined as not being a required property, and can be usable to define a description of the action group. In one example, the “version” property may be of a string type, may be defined as not being a required property, and can be usable to define a version of the action group. In one example, the “actions” property may be of a list type, may be defined as a required property, and can be usable to provide a list of actions that are part of the agent action group.

Examples of application event subscription properties can include, for example, “context,” “event,” “semantic object,” and “agent action.” In one example, the “context” property may be of a string type, may be defined as a required property, and can reflect a context as set in an update application context command message. In one example, the “event” property may be of a string type, may be defined as a required property, and can reflect an event as set in an update application context command message. In one example, the “semantic object” property may be of a string type, may be defined as not being a required property, and can reflect a semantic object as set in an update application context command message. In one example, the “agent action” property may be of an agent action type, may be defined as a required property, and can be usable to define the agent action that should be executed when the event is emitted.

Examples of application event property mapping properties can include, for example, “name,” “agent action parameter,” and “default value.” In one example, the “name” property may be of a string type, may be defined as a required property, and can reflect the name of a property as set in an update application context command message. In one example, the “agent action parameter” property may be of an agent action parameter type, may be defined as a required property, and can be usable to define the agent action parameter that should be populated with the property value. In one example, the “default value” property may be of an object type, may be defined as not being a required property, and can be usable to define the default value that should be used for the agent action parameter when the property is not set in the update application context command message.

When creating an action, an action parameter can be created for each top-level property in an associated JSON schema. While the parameters can be derived from the schema, the parameters may also be stored in a table at least for purposes of defining display settings for each parameter that can be used during slot filling. For example, the various parameter properties may be set as follows: the “name” property may be set to the name of the property; the “description” property may be set to the description of the property; the “type” property may be set based on the type value in the schema; the “label property may be set to the title property of the schema property (if the title is not set, the “label” can default to the “name”); the “display sequence” property may be incremented while looping over the JSON schema properties (and may be assigned randomly); the “required” property may be taken from the schema; the “default value” property may be taken from the schema; the “allowable values” property may be populated from an “enum” property in the schema (if defined); and the “multi value” property may be set to “true” when the type is an array.

When a JSON schema of an existing action is updated, the parameter list may be reconciled. For example, an action parameter can be created for any properties that are added in the new version of the schema. Likewise, action parameters that no longer have a corresponding property in the schema can be removed. For properties that exist in both old and new version of the schema, the parameter may be updated. This updating may not, however, apply to changed display settings, nor to a changed description.

When a plugin manifest is imported into an agent for the first time in an agent, a number of things may occur. For example, an agent action group can be created with a “plugin” type, and the name, version and description properties may be taken from the manifest. For each semantic action in the plugin manifest, an agent action can be created. With respect to the agent action(s), the name and description may be copied from the manifest; the “type” may be set to “plugin semantic action;” the “generate response message” flag can be set to “true;” the “parameters JSON schema” property may be set to the schema of the semantic action; the “slot filling mode;” property can be set to FORM; and the “response type” may be set to CMM. For each property in the JSON schema, an action parameter can be created, as described above.

When a plugin manifest is re-imported, the action group and its actions will already exist. In this case, the actions list may be reconciled by a creating a new action is for semantic actions that are added in the new version of the manifest and removing actions that no longer have a corresponding semantic action in the manifest. For actions that exist in both old and new version of the manifest, the action may be updated. This updating may not, however, apply to changed display settings, nor to a changed description.

When an Open API specification is imported into an agent for the first time, a number of things may occur. For example, a rest service can be created at the instance level for each path in the specification. In this case, the “name” property may be set to the path, prefixed with the specification title if set. In some examples, any characters not allowed in the “name” may be replaced with underscores. The “description” property may be set to the path description if provided, prefixed with the spec title if set, and the “auth type” property can be set to “none.” This may be subsequently changed via a rest service UI when authentication is needed. The “endpoint” property may be set to the path, prefixed with a base URL that is taken from the first server entry in the specification. In some examples, the URL http://www.example.com may be used as default when no server entry is found in the specification.

For each endpoint method (e.g., POST, PUT, GET, DELETE) a rest service method property is created. In an example, a “method type” property may be set to the path operation, a “request body” property may be set to an operation request body (if available), a “status code” property may be taken from a first operation response, and a “parameters” property may be set based on the query and path parameters defined for the operation.

An agent action group may thereafter be created and may have an Open API type. The “name,” “version” and “description” properties can be taken from the API specification. For each endpoint method in the specification, an agent action may be created. In an example, the “name” and “description” properties can be copied from the API specification, the “type” property can be API call, the “generate response message” flag may be set to “true,” the “parameters JSON schema” property may be set to the schema of the endpoint method in the API specification, the “slot filling mode” property may be set to FORM, and the “response type” property may be set to JSON. As described above, an action parameter can be created for each property in the JSON schema.

When an Open API specification is re-imported, the action group and its actions will already exist. In this case, the actions list may be reconciled by creating a new action for endpoint methods that are added in the new version of the specification and removing actions that no longer have a corresponding endpoint method in the specification. For endpoint methods that exist in both the old and new version of the specification, the action may be updated. This updating may not, however, apply to changed display settings, nor to a changed description.

As depicted in FIG. 2, when an asset 210 is an API specification, a user interface 235 that may be similar to the user interface that can be used to create and configure an agent 145 may be provided for API configuration. For example, the API configuration user interface 235 may include a number of fields that can accept natural language inputs from a user 110. In the example of FIG. 2, the fields of the user interface may include, among others, fields via which a user 110 can identify/name the API, enter a function of the API, provide model prompt information for the API, and enter parameters for the API, including an API name, type, and description. An API configuration user interface may also allow more than one function of a given API to be configured.

The information necessary to define the agent 145 and its actions may reside in a container. The container (and thus the agent) can be searchable and selectable by a component of a digital assistant, which can use the agent information in the container to execute the agent actions, such as by making API calls or accessing identified knowledge documents. In other examples, the container may be a container image that may include one or more executable applications. The container image may include computer-readable code for executing an agent application and a filesystem, which can be used by the agent 145 to execute one or more actions during operation. The container image may also include application and system libraries, default setting values, and any other components or data needed by the one or more applications for standalone execution of the one or more actions defined for the agents 145. In some examples, the container image may be a Kubernetes image or a Docker image.

The prompt-based agent composition tool 155 can allow a multitude of different agents 145 to be configured for different purposes. For example, an agent 145 or multiple agents 145, can be created and configured to define an action or a number of different actions when utilized by digital assistants, such as digital assistants related to 401k plans or item ordering, as described above. As depicted in FIG. 2 and described above, configuring an agent 145 can involve defining specification parameters for the agent 145. The specification parameters may be defined based on natural language input from a user. The specification parameters can include, for example, an agent identifier (e.g., Name) 225, a purpose of the agent (e.g., Description) 230, and an identification of one or more assets 210 for implementing the purpose of the agent 145. As shown, the agent configuration process may include providing the agent 145 with an asset name or description and an asset type. In the example of FIG. 2, configuration of the agent 145 is shown to include providing the agent 145 with the location of an API specification (i.e., 401k Contribution Open API specification 235) and knowledge documents (i.e., 401k Contribution Documents) that can be used by the agent 145 to execute one or more actions for implementing the purpose of the agent 145. When an asset 210 is an API specification, the API location can be provided, for example, as a URL. When an asset 210 is a knowledge document, the document source can be, for example, an existing URL of the document or an identifier of the document when the document has been uploaded into an instance-level document store. In some examples, API specifications and knowledge documents may be stored in instance-level document stores such as organization data stores related to the purpose of a given agent 145. For example, when the purpose of an agent 145 relates to a 401k plan, API specifications and knowledge documents may be stored in one or more human resources databases.

The API specification can include rules to facilitate interaction with another application, such as an application for administering or otherwise making changes to a 401k plan of an end user of the digital assistant with which the agent 145 is associated. Similarly, knowledge document assets can provide rules, instructions, restrictions, or other parameters for guiding or governing performance of the agent actions. For example, if an end user of a 401k-related digital assistant requests a contribution increase, a related knowledge document may provide information about the maximum yearly 401k contribution amount. Together, API specifications and knowledge documents can provide all of the information and capabilities required when the purpose of the agent 145 is implemented by the digital assistant.

Once the agent 145 has been provided with the location of the one or more assets 210, the agent 145 can automatically define configuration information for the one or more assets 210. Defining configuration information for the one or more assets 210 can involve accessing a specification, such as an API specification or a specification in the form of a knowledge document, for each of the one or more assets 210. Configuration information for each asset 210 may then be extracted from a corresponding asset specification and the configuration information may be written into the container. The configuration information may be stored in a configuration file(s) within the container for use by the digital assistant when executing the agent action(s). When the agent 145 is an executable agent associated with a container image, the asset configuration information can be used by the agent 145 to implement the purpose of the agent 145.

The main function of the agent 145 involves defining actions for execution by a digital assistant. As such, configuring the agent 145 can further include defining one or more actions 220 of the agent based on the configuration information, the natural language input from a user 110, or both. An action 220 can be an explicit action that is authored using natural language. For example, an explicit action such as the “What is the impact of XYZ on my 401k Contribution limit?” action in the “401k Contribution Agent” of FIG. 2 may be created in a similar manner to that described above relative to one or more of the agent artifacts 205. Alternatively, an action 220 may be an implicit action that is automatically created when an asset 210 is imported upon pointing the agent 145 to a given asset 210 based on metadata and/or specifications associated with the asset 210.

In the example of the agent 145 illustrated in FIG. 2, a user 110 can easily create explicit actions. For example, if the user 110 discovers that a new FAQ needs to be added because the FAQ is not currently in the knowledge documents of the assets 210 that the agent 145 references (meaning it was not implicitly added as an action), the user 110 can choose the “Rich Text” action type and create the name artifact “What is the impact of XYZ on my 401k Contribution limit?” As shown in FIG. 1 and as indicated in Table 1 below, other action types are also possible. For example, instead of the “Rich Text” action type, the user 110 may choose a “Prompt” action type when the desired result of the action is a prompt to a large language model (LLM) associated with a related digital assistant 115. Alternatively, the user 110 may choose a “Flow” action type in, for example, a case where the user 110 is not able to use standard dialogue and dialog customizations. Other action types other than those shown in FIG. 2 and Table 1, and specifically described herein are also possible.

TABLE 1

| | Action Type | Description |
|---|---|---|
| 1 | Prompt | The action is implemented using a prompt to an LLM. |
| 2 | Rich Text | The action is implemented using rich text. |
| | | The most common use case is FAQs. |
| 3 | Flow | The action is implemented using Visual Flow |
| | | Designer flow. May be used for complex cases |
| | | where the developer is not able to use the |
| | | out-of-the-box dialogue and dialog customizations. |

Configuration of the agent 145 can further include generating a specification document for the agent 145. The specification document may include description metadata associated with the agent 145. For example, the specification document may include top-level metadata which may be metadata associated with specification parameters such as, for example, the agent name or other agent identification information, the agent purpose, etc. The specification document may also include metadata associated with the one or more assets 210 of the agent 145, or metadata associated with the one or more actions 220 of the agent 145, or various combinations of such top-level, asset, and action metadata. Generating the specification document may comprise acquiring, from the agent, metadata associated with the specification parameters, the one or more assets, the one or more actions, or any combination thereof. The description metadata may be associated with an identifier of the agent. The description metadata and the identifier may be written into the specification document, such that the specification document describes the agent 145 and elements of the agent 145 including the one or more assets 210 and the one or more actions 220. Inclusion of the description metadata and the identifier in specification document can facilitate location of the agent 145 in a subsequent search operation for candidate agents that may be usable to respond to a natural language utterance provided to a digital assistant by an end user.

Once the specification document has been generated, the specification document can be stored in a data store that is communicatively coupled to the digital assistant. In some examples, the data store can be a context and memory store, such as the context and memory store 314 shown in FIG. 3 and described in more detail below. Agent specification documents may be indexed in the context and memory store as one or more indices. The one or more indices may thus provide a comprehensive record of the capabilities of all existing agents 145 and associated assets that are available to a digital assistant for responding to a request. The indices may be provided as data structures that can facilitate quick and efficient look up and retrieval of agent information via the description metadata and the agent identifier information of the stored specification documents. In this manner, a digital assistant can quickly identify and select one or more agents 145 from a multitude of candidate agents that may be usable to respond to a request of an end user of the digital assistant.

Once an agent 145 has been created and configured, the functionality of the agent 145 may be tested. For example, the functionality of an agent 145 when used by a digital assistant to implement the purpose of the agent 145 may be tested by a generative artificial intelligence model using a natural language utterance from the user. In some embodiments, the prompt-based agent composition tool 155 can be the generative artificial intelligence model. In some examples, testing of an agent 145 may be an interactive process between the user and the generative artificial intelligence model. The interactive testing process may be initiated by receiving and evaluating the natural language test utterance from the user 110, which may be intended to mimic receipt by a digital assistant of a natural language utterance from an end user of the digital assistant. The evaluation of the natural language utterance may be based on the specification document for the agent 145 that was previously generated and stored. In response to receiving the test utterance, the interactive testing process may select the agent 145 for use in responding to the natural language utterance based on evaluating the natural language utterance. Selection of the agent 145 may be based on the description metadata and the identifier associated with the specification document.

The interactive testing process may then generating an execution plan comprising the one or more actions 220 defined for the agent 145. The interactive testing process may then execute, based on the execution plan and the configuration information for the one or more assets 210 of the agent 145, the one or more actions 220 to obtain output data. Executing the one or more actions 220 of the agent 145 on the one or more assets 210 of the agent 145 may involve calling one or more API assets associated with the agent 145 to facilitate communication with another application. Executing the one or more actions of the agent 145 on the one or more assets of the agent 145 may instead or additionally involve reading one or more knowledge document assets associated with the agent 145. In any case, executing the one or more actions 220 of the agent 145 results in obtaining the output data from the one or more assets 210 based on the execution of the one or more actions 220.

The interactive agent testing process may then generate a response to the natural language utterance based on the output data obtained from the one or more assets 210 of the agent 145. The response can then be evaluated to determine the functionality of the agent 145 to implement the purpose of the agent 145. Evaluating the response may result in receiving acceptance of the response from the user 110, whether through an additional natural language utterance or another natural language input. Alternatively, if the user 110 deems the generated response to be unacceptable, the user 110 may provide additional natural language input concerning a change to the specification parameters or the one or more actions of the agent 145. The additional natural language input from the user can result in a reconfiguring of the agent 145 based on the change to the specification parameters, and retesting of the agent 145. The user 110 may also provide additional natural language input concerning a change to the specification parameters or the one or more actions of the agent 145 prior to generation of the response, such as after selection of the agent 145, running of the agent 145, or obtaining data from the one or more assets 210 of the agent 145. When the user 110 provides additional natural language input during the interactive agent testing process, any changes to the specification parameters or the one or more actions 220 of the agent 145 based on the additional natural language input from the user 110 may be executed.

With respect to agent configuration and testing, as described above, a user 110 is not an end user of a digital assistant that utilizes an agent 145. Rather, a user 110 is a person who creates and configures an agent 145. In some examples, the user 110 may be a developer or another person skilled in tasks such as agent configuration. In such a case, the user may configure an agent 145 by, for example, entering required information into the fields of the above-described user interface, pointing the agent to the location of assets, etc. In other examples, the user 110 may be a person such as a business analysts who is not skilled in tasks such as agent configuration, but may be knowledgeable regarding tasks for which a digital assistant may be utilized by an end user. In this latter case, an agent configuration process may allow the user 110 to configure an agent 145 through only natural language utterances, such as by utilizing an LLM-based agent composition tool and associated procedure to provide an agent 145 with information by which the purpose of the agent 145 can be understood or deduced, and subsequently using the LLM-based agent composition tool to engage the user 110 in a mock conversation from which specification parameters for the agent 145 can be extracted. In some examples, the LLM-based agent composition tool may be associated with the DABP 105 and may an aspect of the agent composition tool 155. In other examples, the LLM-based agent composition tool may be a tool that is separate from the DABP 105, or part of the DABP 105 but separate from the agent composition tool 155.

Once the agent 145 has been configured, receipt of a natural language utterance as a user input to the digital assistant can cause the digital assistant to generate a response to the natural language utterance based on the specification document and the agent 145. In some examples, generating the response may initially comprise executing, using the natural language utterance, a search on specification documents in the data store, wherein the specification documents include the specification document for the agent 145. Based on the search, one or more candidate agents (which include the agent 145) and associated actions for generating the response can be identified. An input prompt to a first generative artificial intelligence model can then be generated by combining metadata obtained from specification documents for the one or more candidate agents with the natural language utterance, wherein the metadata includes the metadata written in the specification document for the agent. The first generative artificial intelligence model can thereafter, based on the input prompt, generate an execution plan for responding to the natural language utterance, wherein the execution plan includes an order list of actions comprising the one or more actions of the agent. The one or more action can then be executed, based on the execution plan and the configuration information for the one or more assets, to obtain output data. Using the output data, an output prompt can then be generated for a second generative artificial intelligence model of the digital assistant. The second generative artificial intelligence model may be the same or different from the first generative artificial intelligence model. A response to the natural language utterance can thereafter be generated by the second generative artificial intelligence model based on the output prompt.

One example of configuring the Change Contribution Agent (hereinafter “Agent”) 200 of FIG. 2 using an LLM-based agent composition tool is illustrated in FIGS. 3-10. In the example of FIG. 3, a simulated user named Lisa utilizes the LLM-based agent composition tool to configure the Agent 200 for use by a digital assistant (or DA). For purposes of this example, Lisa is intended to represent a non-developer user, such as a business analyst, who has less understanding about agent creation and configuration than a developer or another technician.

As depicted in FIG. 3, Lisa desires to create the Agent 200 for use in a scenario where end-users wish to change 401k contributions. To this end, the LLM-based agent composition tool can initiate a conversation 300 with Lisa, or Lisa can initiate a conversation with the LLM-based agent composition tool, with the goal of creating the Agent 200 and providing the Agent 200 with the ability to execute one or more actions that can change an end-user's 401k contribution. Lisa may provide the LLM-based agent composition tool with information about the desired Agent 200 via natural language input, which may be, for example, a textual natural language input or a natural language utterance. As indicated in FIG. 3, Lisa has used the term “Agent” in her initial dialogue 302, but use of that specific term is not necessarily required to initiate the desired interaction with the LLM-based agent composition tool. Lisa also provides in her initial dialogue 302, a general description of the intended function of the Agent 200, as well as some information about how an end-user can change their 401k contribution (e.g., by percentage or by amount) and about the types of questions the end-user may ask the digital assistant. Lisa also indicates that annual contribution information and company matching policy information can be found in a knowledge document asset located at a URL that Lisa provides.

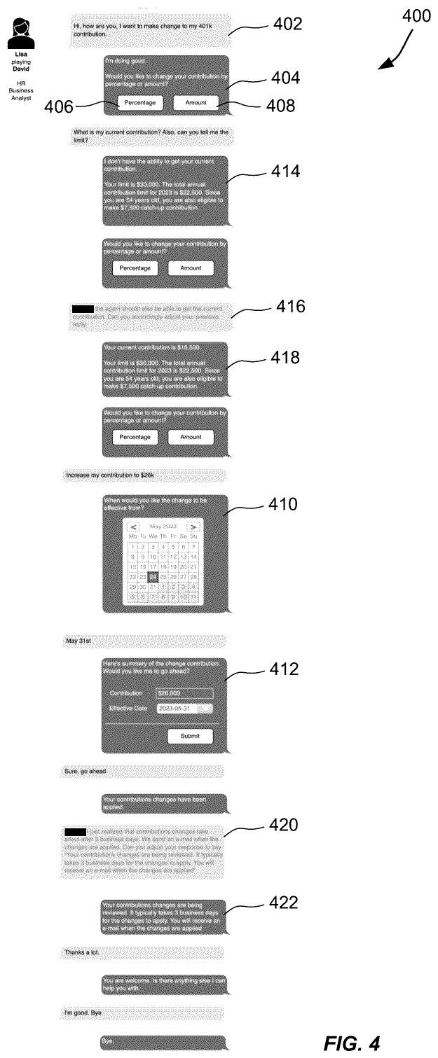

As indicated at 304, the LLM-based agent composition tool can acknowledge Lisa's dialogue, and can then internally create a draft version of the Agent 200. The LLM-based agent composition tool understands that it does not currently have the API information necessary to make an actual 401k contribution change, but does not need to ask for the information at this stage of the process, as the API information can be gathered later. As indicated at 306, the LLM-based agent composition tool can then start the mock conversation flow to configure the Agent 200. The LLM-based agent composition tool can explain the simulated roles that Lisa and the LLM-based agent composition tool will play during the mock conversation. In this example, Lisa will play the role of an end-user, while the LLM-based agent composition will play the role of the Agent 200. As also indicated at 306, the LLM-based agent composition tool may additionally inform Lisa how she can modify the behavior of the LLM-based agent composition tool and the Agent 200 while role playing. As indicated at 308, Lisa responds that she will play the role of an end-user as instructed, and selects the name David Smith and an age of 54 for the simulated end-user. The LLM-based agent composition tool can have already begun to internally create artifacts (agents, digital assistants, or some other intermediate form, etc.) at this point of the agent creation and configuration process but, in this example, the LLM-based agent composition tool does not expose any of this complexity to Lisa nor does the LLM-based agent composition tool ask or require Lisa to fit her scenario to the artifacts. The LLM-based agent composition tool then engages Lisa in a mock conversation 400 as shown in FIG. 4.

It may be observed in FIG. 4 that Lisa and the LLM-based agent composition tool engage in a running mock conversation 400 wherein Lisa poses questions as “David,” and the LLM-based agent composition tool provides responses and poses queries as the Agent 200. Lisa also corrects the LLM-based agent composition tool as Lisa—i.e., in her business analyst role of creating and configuring the agent rather than in her role as the simulated end-user David. As Lisa expects David to talk to the Agent 200 like a human, David's initial dialogue 402 with the LLM-based agent composition tool begins with typical pleasantry and then progresses to a stated goal of changing his 401k contribution. As indicated at 404, the LLM-based agent composition tool in its role as the Agent 200 can respond to David's pleasantry and may then start a conversation with David with the goal of satisfying David's request. As may be understood from FIG. 4, the LLM-based agent composition tool can decompose David's inputs (e.g., utterances) into multiple statements/questions and can respond appropriately. The conversation format may vary across different examples, but in this example, the conversation format is that of a typical business style interaction.

As shown in FIG. 4, the LLM-based agent composition tool also assumes in this example that end-user David is interacting with it via a channel whereby David can provide multi-modal input (e.g., not only a natural language input). Consequently, in this example, the Agent 200 provides buttons 406, 408 by which David can furnish responsive information. When such buttons are presented, Lisa can instruct the LLM-based agent composition tool to modify the button labels or positioning. The LLM-based agent composition tool may also impart the Agent 200 with a diverse library of other widgets (e.g., calendars 410, etc.) that the Agent 200 can display and use to make it easy for David to provide input. The LLM-based agent composition tool may operate such that task dialogs presented to the end-user will provide a summary at the end of the mock conversation by default. The LLM-based agent composition tool may also present forms, such as for example, information entry interfaces 412, that include selectable buttons, fillable fields, or other mechanisms that make it easier for an end-user to supply information, make changes to presented information, etc.

It may also be observed at 414 that the during the mock conversation, the LLM-based agent composition tool informs David that the Agent 200 cannot be used to retrieve his current contribution amount as requested. This is because the LLM-based agent composition tool has, at this point, limited its knowledge only to the information Lisa has provided and the capability of other agents that exist in the digital assistant, and thus does not currently have David's current contribution amount. As indicated at 416, Lisa then instructs the LLM-based agent composition tool that the use of the Agent 200 should be able to obtain and present the contribution amount, and thereby adds a new retrieval capability (get current contribution) for this purpose. As indicated at 418, the contribution limit amount is then retrieved from the knowledge document location that Lisa provided in the initial agent description and the LLM-based agent composition tool resultantly change its previous response by providing David's current contribution amount. In other examples where an agent has been provided with both a knowledge document asset and an API asset relative to the same action (e.g., “get contribution amount” or “get contribution limit”), a default API asset versus knowledge asset preference may be built-in and consulted to determine which asset should be used to perform the action. When present in some examples, a default API asset versus knowledge asset preference may be modifiable by a user.

It can also be observed in FIG. 4 that later in the mock conversation (as indicated by 420), Lisa additionally corrects the LLM-based agent composition tool with regard to the LLM-based agent composition tool's response to David about reporting application of his requested 401k contribution change. In this regard, Lisa also instructs the LLM-based agent composition tool that the application of a 401k contribution change is to be reported on the date of application, and provides appropriate language for a corresponding response that should be provided to an end-user (David) by a digital assistant utilizing the Agent 200. As indicated at 422, the LLM-based agent composition tool then adjusts the conversation flow prompt/configuration of the Agent 200 and the response as modified is repeated according to Lisa's instructions. Lisa can expect that the LLM-based agent composition tool and the resulting Agent 200 will take this instruction into account in the future. The understanding of the core aspects of the mock conversation by the LLM-based agent composition tool can improve based on feedback received from Lisa.

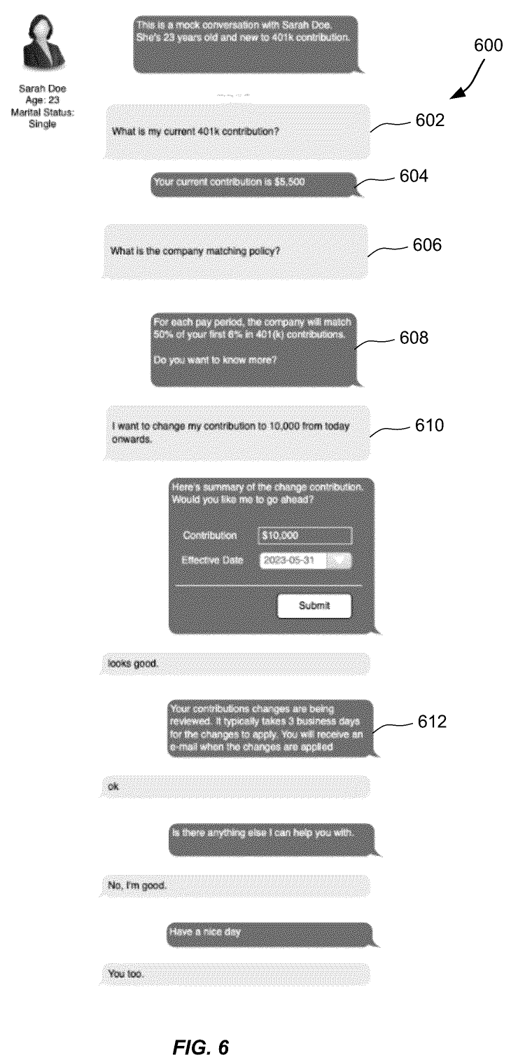

FIGS. 5-6 illustrate an example of conversation flow confirmation and testing after using the LLM-based agent composition tool to create and configure the Agent 200. Flow confirmation and testing may be accomplished, for example, by presenting one or more mock conversations to the user that used the LLM-based agent composition tool to create and configure the agent (Lisa, in this example). In this regard, FIG. 5 presents a mock conversation 500 between a simulated end-user named Tom and a simulated digital assistant that can utilize the Agent 200 configured using the LLM-based agent composition tool. FIG. 6 presents a similar mock conversation 600 between a simulated end-user named Sarah and the digital assistant. Each mock conversation 500, 600 is directed to issues related to a 401k plan. Through the mock conversations 500, 600, it may be better ensured that Lisa can accept a certain variability in some parts of the conversations, and also that the LLM-based agent composition tool understood that parts of the conversations should not be varied (e.g., the message about the 3 day time period to review a contribution change). Generation and presentation of such mock conversations 500, 600 can help a user gain confidence in the LLM-based agent composition tool's understanding of the conversation flow. Mock conversation flows may be saved as test cases in some examples.

As indicated at 502 of FIG. 5, Tom initiates a conversation 500 with the simulated digital assistant regarding his ability to increase his 401k contribution. In response, the simulated digital assistant retrieves Tom's current contribution amount using the Agent 200 (per Lisa's previous correction) and instructs Tom as to his contribution limit, as indicated at 504. In this case, the contribution limit information presented to Tom is obtained from the knowledge document to which Lisa directed the Agent 200. The simulated digital assistant and Tom then engage in further conversation wherein Tom instructs the simulated digital assistant, as indicated at 506, as to what extent he would like to increase his contribution limit and the simulated digital assistant confirms with Tom the amount and the timing of the contribution change. As can be observed at 508, the simulated digital assistant also provides Tom with the “3 business day” notice and email information as instructed/provided by Lisa during the LLM-based agent configuration process. After engaging in some later pleasantry related to ending the conversation, Tom interjects with a request for the simulated digital assistant to perform an action that is outside of the scope (purpose) of the Agent 200, as indicated at 510. As represented by the ensuing conversation, the simulated digital assistant may include an advanced ability (e.g., routing/reasoning ability) and a built-in feedback capability that allows the simulated digital assistant to understand and respond to such requests. For example, as represented here at 512, the simulated digital assistant informs Tom that it lacks the ability to perform the requested task. In this example, the simulated digital assistant also asks Tom if the simulated digital assistant should log the action as an enhancement request.

In FIG. 6, Sarah initiates a conversation 600 with the simulated digital assistant by querying the simulated digital assistant as to the amount of her current 401k contribution, as indicated at 602. In response, the simulated digital assistant retrieves and presents Sarah's current contribution amount using the Agent 200, as indicated at 604. At 606, the simulated digital assistant then fields and responds to a question from Sarah regarding the company matching policy, and the requested information is again obtained from the knowledge document to which Lisa directed the Agent 200 during the agent configuration process. As indicated at 608, in this example, the simulated digital assistant also asks Sarah if she would like to know more about the company matching policy, but Sarah responds with an instruction rather than a response to the question, as indicated at 610. The simulated digital assistant is able to understand Sarah's implied “No” response to the question and, therefore, moves forward with the process of causing the Agent 200 to execute Sarah's requested Change Contribution action. The simulated digital assistant and Sarah then engage in further conversation wherein, at 612, the simulated digital assistant also provides Sarah with the appropriate “3 business day” notice and email information prior to the ending of the mock conversation. The “3 business day” notice and email information is one example where the simulated digital assistant intentionally does not vary the message language as a result of the Agent configuration process.

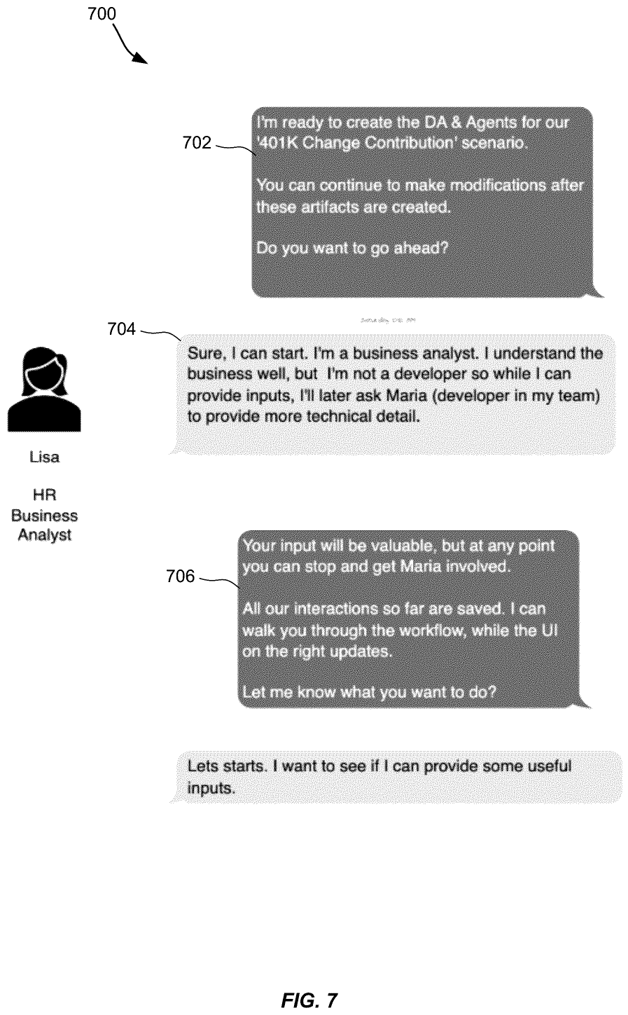

An example of a next step of creating a digital assistant and Agent artifacts is represented in FIG. 7. For purposes of this example, it is assumed that the user (Lisa) started the agent creation and configuration process described above and illustrated in FIGS. 3-6 with an empty digital assistant and thereafter added the described and shown capabilities. In the interaction represented in FIG. 7, the LLM-based agent composition tool initiates the creation of artifacts. While as a non-developer, Lisa may not be able to complete the artifact creation process, Lisa can nonetheless provide valuable inputs at this point or can hand over the rest of the process to someone more technically skilled, such as a software developer (Lisa's teammate Maria in this example).

As represented in FIG. 7, the LLM-based agent composition tool may generate a mock conversation 700 regarding the creation of artifacts. The mock conversation 700 can help the LLM-based agent composition tool gather more information about the scenario, and the sample conversation 700 can help to ensure that Lisa obtains a better understanding of the behavior of a digital assistant when utilizing the Agent 200. As indicated at 702, the LLM-based agent composition tool may begin the mock conversation 700 by, for example, informing Lisa that it is ready to begin creating the digital assistant and Agent 200 artifacts for the “401k Change Contribution” scenario for which Lisa previously engaged in the LLM-based agent creation and configuration operation. The LLM-based agent composition tool may also ask Lisa if she wants to proceed, and can respond to Lisa's response in an appropriate manner. At 706, for example, the LLM-based agent composition tool acknowledges Lisa's admission 704 that she is not a developer and will likely ask Maria to provide more technical details at some point in the process. The LLM-based agent composition tool may also offer guidance regarding the artifact creation process.

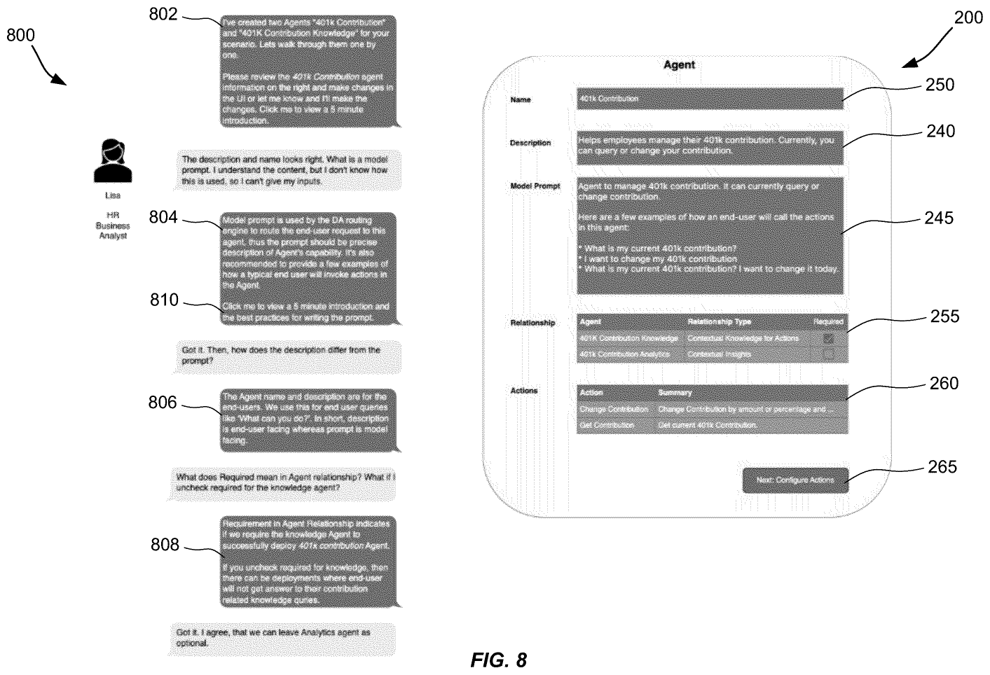

FIG. 8 represents one example of a next step in the digital assistant and Agent artifact creation process. In this case, the LLM-based agent composition tool operates to generate top-level metadata for the Agent 200 by engaging Lisa in further conversation 800. The LLM-based agent composition tool can use the initial scenario description and subsequent suggestions made during the previous mock conversation(s) with Lisa to create a draft version of Agent top-level metadata. As represented at 802, the LLM-based agent composition tool can identify to Lisa the Agents 200 that were created as a result of the previous agent creation and configuration process. Also, in this example, it may be observed that the Description field 240 and the Prompt field 245 of the Agent 200 have already incorporated the contribution query information. The presented Prompt follows the best practice and also includes a few examples. The examples include the invocation of single and multiple actions. The LLM-based agent composition tool may guide Lisa through additional operations such as providing an identifier (e.g., Name) 250 for the Agent 200, and providing or modifying one or more of the Description and Model Prompt information, Relationship information 255, and Actions information 260 for the Agent 200.

As represented at 804, 806, and 808, the LLM-based agent composition tool can describe each type of information within the artifact creation user interface, and may also present selectable text 810, a selectable button or another selectable object by which Lisa can view additional guidance and information regarding one or more of the requested types of information. Through this conversation and guidance, any of the information provided or modified by Lisa can be used by the LLM-based agent composition tool to configure the Agent 200. While Lisa does not make any changes to the Agent fields, or the information to be inserted into the Agent fields, etc., in this example, an analyst such as Lisa may provide valuable suggestions or changes in another example. Based on the information and guidance provided by the LLM-based agent composition tool, Lisa can develop an understanding that, for example, the information in the Name and Description fields of the Agent 200 is end-user-facing and commonly used in help/discovery interactions. Lisa can similarly be made to understand the role that the information in the Model Prompt and Relationship fields plays in routing user queries and deploying the Agent 200. Lisa is thus ready to review the Agent actions, which she may do by clicking on the presented “Configure Actions” button 265 in this example. It is also possible that Lisa may verbally instruct the LLM-based agent composition tool to move on to a review of the Agent actions.

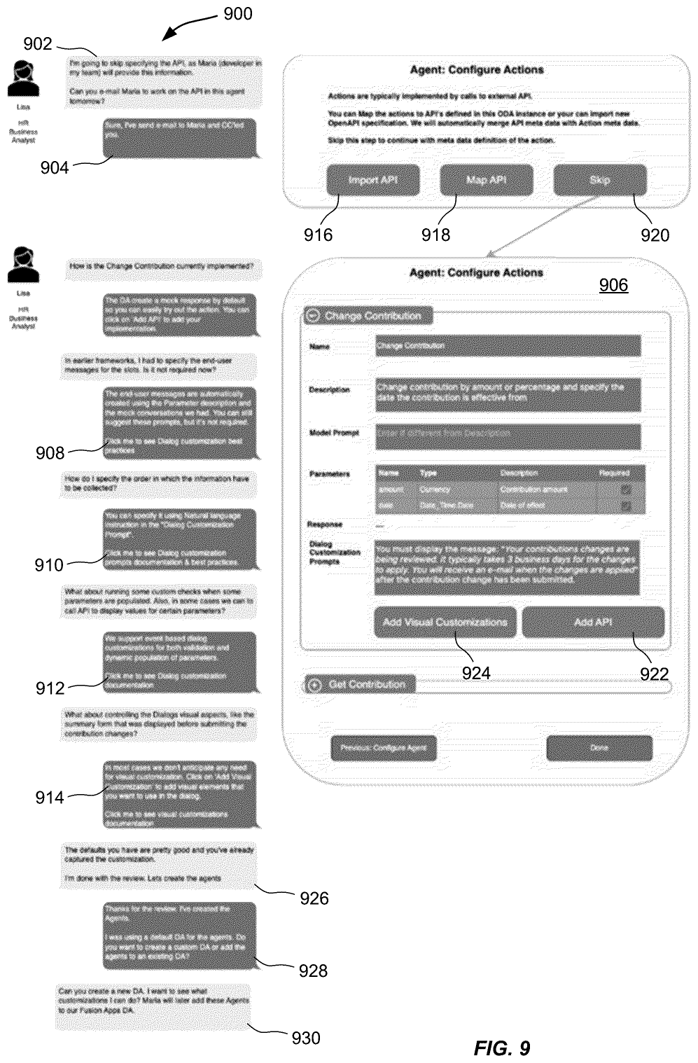

FIG. 9 represents one example of a further step in the digital assistant and Agent artifact creation process. In this example, the LLM-based agent composition tool operates to generate actions metadata for the Agent 200. Lisa and the LLM-based agent composition tool can engage in a further conversation 900 for this purpose. The conversation 900 may be initiated upon Lisa's selection of the “Configure Actions” button 265 at the end of the top-level metadata creation process represented in FIG. 8 or upon verbal instructions from Lisa to the LLM-based agent composition tool for the same purpose. As indicated at 902, Lisa informs the LLM-based agent composition tool at the onset of the conversation 900 that she is going to skip specifying the API action for the Agent 200 and that a developer on Lisa's team named Maria will instead provide the detailed API information. Lisa also asks the LLM-based agent composition tool if it can send an email to Maria in that regard, and the LLM-based agent composition tool confirms that it has done so, as indicated at 904. In this manner, Lisa can configure the Agent 200 to the extent of her abilities and knowledge as a business analyst, and more technical aspects of the Agent 200 may be configured by a more skilled user, such as the developer Maria. Such a team approach to agent creation and configuration may be more efficient than requiring all agents to be created and configured by a technician such as a developer. Instead, the bulk of a given agent creation and configuration operation can be completed by individuals with intimate knowledge of the tasks for which the agents will be used, and then a developer or similar technician can quickly complete the agents when needed by adding API details or specifying other actions.

As was the case with use of the LLM-based agent composition tool to create top-level metadata, it may be observed in FIG. 9 that Lisa can ask various questions regarding how certain actions of the Agent 200 are implemented, or how she can specify different aspect of the Agent actions. In response, the LLM-based agent composition tool can answer Lisa's questions, explain different options, describe each type of information that is to be provided in the various fields of an associated agent actions configuration user interface 906, and may again present selectable text 908, 910, 912, 914 or a selectable button or another selectable object by which Lisa can view additional guidance and information regarding one or more actions of the Agent 200. As shown the Agent actions configuration user interface 906 may also help guide the Agent actions configuration process. In this example, the agent actions configuration user interface 906 describes that actions are typically implemented by calls to an external API(s) and that the user can map actions to APIs defined in this digital assistant instance or new Open API specifications can be imported. The agent actions configuration user interface 906 also explains, in this example, that API metadata will be automatically merged with action metadata. Selectable buttons 916, 918, 920 are also provided in this example via which Lisa can elect to import an API, map an API, or skip specifying an API, respectively.

In some examples, the agent actions configuration user interface 906 may be similar to the agent actions API configuration user interface 235 shown in FIG. 2. For example, the agent actions configuration user interface 906 may include a number of fields that can accept natural language inputs from a user for the purpose of configuring the API. In the example of FIG. 9, the agent actions configuration user interface 906 can be seen to include fields by which a user can identify/name the action to be performed by the API, enter a description for the action, provide model prompt information for the action, enter parameters for the action, and define custom dialog prompts for the digital assistant. The agent actions configuration user interface 906 may also allow more than one function of a given API to be configured. Once the required information has been entered into the agent actions configuration user interface 906, such as through the conversation between the LLM-based agent composition tool and Lisa (or Maria), the API may be added to the Agent 200 in this example by clicking the “Add API” button 922. In this example, the agent actions configuration user interface 906 also includes a “Add Visual Customizations” button 924 to allow a user to add visual elements to the dialogue that will be provided by the digital assistant.

Once Lisa is satisfied that the default API configuration information provided by the LLM-based agent composition tool is sufficient and accurate, or has customized the information or caused the LLM-based agent composition tool to provide other API configuration information, Lisa can instruct 926 the configuration information to create the Agent 200. As indicated at 928, the LLM-based agent composition tool then confirms that it has created the Agent 200. In this example, the LLM-based agent composition tool also asks Lisa if she wants to create a custom digital assistant with which the Agent 200 will be used, or if she wants to add the Agent 200 to an existing digital assistant. In this case, Lisa elects 930 to have the LLM-based agent composition tool create a new digital assistant.

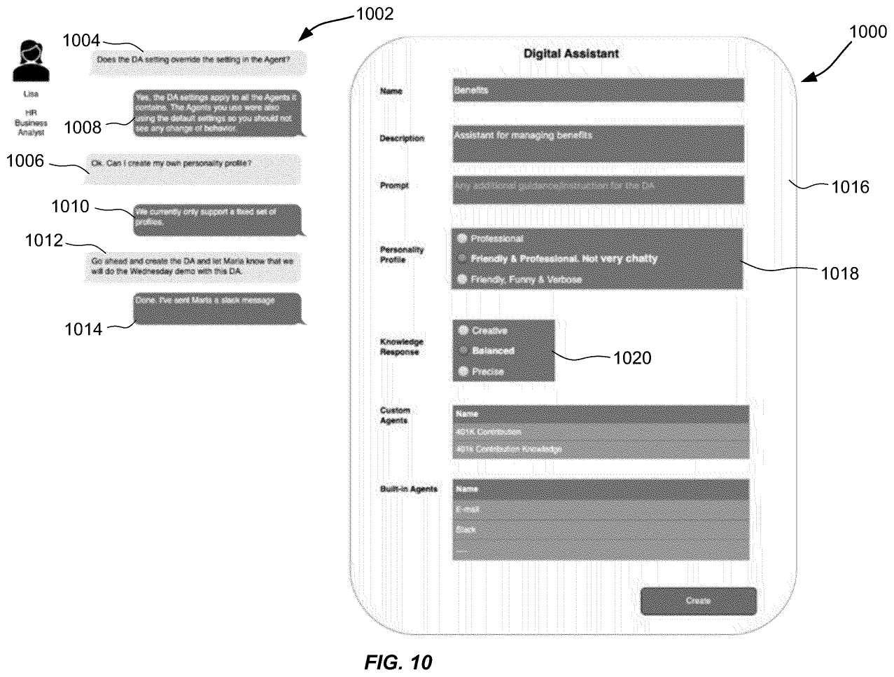

FIG. 10 represents one example of an LLM-based process for creating a digital assistant 1000, which can be undertaken using the digital assistant builder platform (DABP) 105 of FIG. 1 after creation and configuration of the Agent 200 and the agent metadata. In some examples, creating the digital assistant 1000 can be accomplished using additional functionality of the LLM-based agent composition tool. In other examples, the LLM-based agent composition tool may hand off the task of creating the digital assistant 1000 to another tool of the suite of tools 120 of the DABP 105. In any case, the DABP 105 can be used to create the digital assistant 1000 in this example by engaging in a further conversation 1002 with Lisa. The conversation 1002 may be initiated, for example, in response to the instruction to create a new digital assistant that was previously provided by Lisa at the end of the agent actions metadata generation process depicted in FIG. 9.

During the conversation, Lisa can again ask questions 1004, 1006 and the DABP 105 can provide responses 1008, 1010 through which Lisa can gain a better understanding of the various features and parameters that may be associated with the digital assistant 1000. In this regard, the initial dialogue provided by Lisa is a query 1004 as to whether settings in the digital assistant 1000 will override any like settings in the Agent 200. In its response 1008, the DABP 105 in this example explains that the settings of the digital assistant 1000 apply to all the agents it utilizes and, therefore, the settings of the digital assistant 1000 will override any contrary settings of the Agent 200. The DABP 105 also explains that the Agent 200 used default settings during the agent creation and configuration process, so Lisa should see no change in the behavior of the digital assistant 1000 compared to the way the simulated digital assistant acted and conversed during the previous mock conversations during the agent creation and configuration process. Once Lisa has reviewed approved the various digital assistant settings, parameters, characteristics, agents, and other information, which may be presented in a digital assistant user interface 1016, Lisa can instruct the DABP 105 to create the digital assistant 1000, as indicated at 1012. In this example, Lisa also asks the DABP 105 to inform her colleague Maria that they will perform a demo of the digital assistant 1000 on Wednesday. As indicated at 1014, the DABP 105 then acknowledges creation of the digital assistant 1000 and transmission of Lisa's message to Maria which, in this example, is accomplished using one of the built-in communications agents of the digital assistant 1000.

Various digital assistant 1000 setting, parameter, characteristic, agent, or other information may be presented in the digital assistant user interface 1016. For example, as depicted in FIG. 10, the digital assistant user interface 1016 can display for the digital assistant 1000, an identification (e.g., Name), a description of the digital assistant 1000 function, a personality profile, a knowledge response type, the custom agents contained in the digital assistant 1000, and built-in agents of the digital assistant 1000. At least some of the settings, parameters, or characteristics of the digital assistant 1000 may be user selectable. For example, as indicated at 1018, a user (e.g., Lisa) may be able to select between a “professional,” “friendly and professional—not very chatty,” or “friendly, funny and verbose” personality profile for the digital assistant 1000. Likewise, as indicated at 1020, a user may be able to select from a “creative,” “balanced,” or “precise” type of digital assistant knowledge response.

A digital assistant setting such as the personality profile 1018 can help to ensure a consistent end-user experience across agents. The digital assistant creation process may allow for enterprise-specific settings to be made in one place. The information presented relative to a digital assistant may make it easy for a user to understand dependencies across all the Agents. Default/stock digital assistants may be provided with a library of Agents that can make the digital assistant work well for a given enterprise, use case, or scenario without the need for user modification or enhancement.

As should be apparent from the foregoing description, there are various ways in which agents and assets can be associated or added to a digital assistant. In some instances, agents can be developed by an enterprise and then added to a digital assistant using the DABP 105. In other instances, agents can be developed and created using the DABP 105 and then added to a digital assistant created using the DABP 105. In yet other instances, the DABP 105 may provide an online digital store (referred to as an “agent store”) that offers various pre-created agents directed to a wide range of tasks and actions. The agents offered through the agent store may also expose various cloud services.

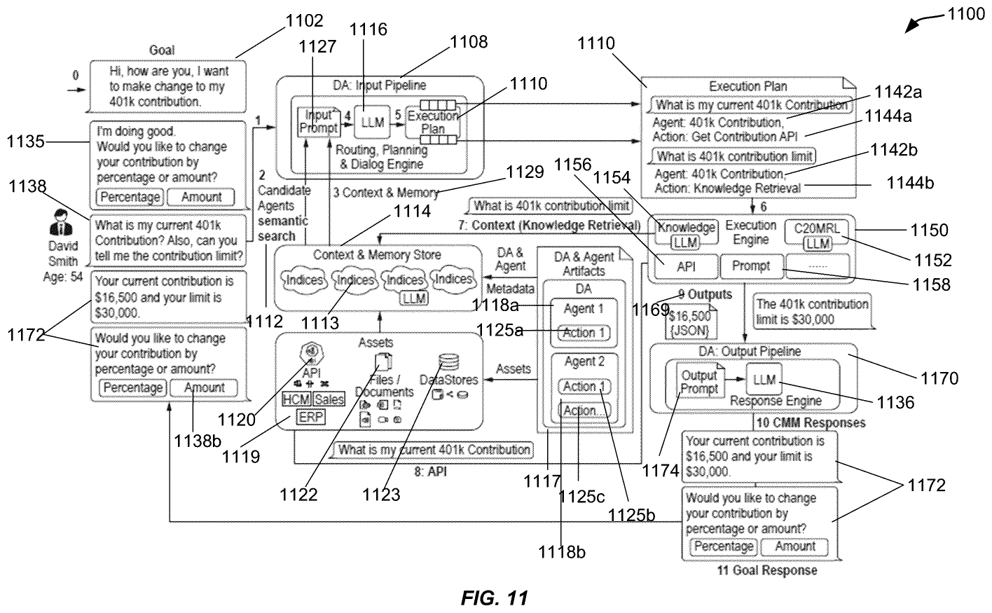

Once deployed in a production environment, such as the architecture described with respect to FIG. 11, a digital assistant, such as digital assistant 115a built using DABP 105, can be used to perform various tasks via natural language-based conversations between the digital assistant 115a and its users 125. As described above, the digital assistant 115a illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115a and get responses 135 back from digital assistant 115a. A conversation can include one or more of user inputs 130 and responses 135. Via these conversations, a user 125 can request one or more tasks to be performed by the digital assistant 115a and, in response, the digital assistant 115a is configured to perform the user-requested tasks and respond with appropriate responses to the user 125 using one or more LLMs 140.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115a. In some embodiments, a user input 130 can be in audio input or speech form, such as when a user says or speaks something that is provided as input to digital assistant 115a. The user inputs 130 are typically in a language spoken by the user 125. For example, the user inputs 130 may be in English, or some other language. When a user inputs 130 is in speech form, the speech input is converted to text form user inputs 130 in that particular language and the text utterances are then processed by digital assistant 115a. Various speech-to-text processing techniques may be used to convert a speech or audio input to a text utterance, which is then processed by digital assistant 115a. In some embodiments, the speech-to-text conversion may be done by digital assistant 115a itself. For purposes of this disclosure, it is assumed that the user inputs 130 are text utterances that have been provided directly by a user 125 of digital assistant 115a or are the results of conversion of input speech utterances to text form. This however is not intended to be limiting or restrictive in any manner.

The user inputs 130 can be used by the digital assistant 115a to determine a list of candidate agents 145a-n. The list of candidate agents (e.g., 145a-n) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115a. Metadata for the candidate agents 145a-n in the list of candidate agents is then combined with the user input to generate an input prompt for the one or more LLMs 140.

Digital assistant 115a is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145a) from the list of candidate agents to execute and perform one or more actions or operations responsive to the understood meaning or goal of the user. The one or more actions or operations are then executed by the digital assistant 115a on one or more assets (e.g., asset 150a—knowledge, API, SQL operations, etc.) and/or the context and memory store. The execution of the one or more actions or operations generates output data from one or more assets and/or relevant context and memory information from a context and memory store comprising context for a present conversation with the digital assistant 115a. The output data and relevant context and memory information are then combined with the user input 130 to generate an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115a is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user responses may be generated by executing an action via an agent (e.g., agent 145a) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115a may also be in natural language form and typically in the same language as the user input 130. As part of generating these responses 135, digital assistant 115a may perform natural language generation (NLG) using the one or more LLMs 140. For the user ordering a pizza, via the conversation between the user and digital assistant 115a, the digital assistant 115a may guide the user to provide all the requisite information for the pizza order, and then at the end of the conversation cause the pizza to be ordered. The ordering may be performed by executing an action via an agent (e.g., agent 145a) on an API asset (e.g., an API for ordering pizza) to upload or provide the pizza order to the ordering system of the restaurant. Digital assistant 115a may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115a including one or more LLMs 140 and one or more agents 145a-n, this is not intended to be limiting. A digital assistant can include various other components (e.g., other systems and subsystems as described in greater detail with respect to FIG. 11) that provide the functionalities of the digital assistant. The digital assistant 115a and its systems and subsystems may be implemented only in software (e.g., code, instructions stored on a computer-readable medium and executable by one or more processors), in hardware only, or in implementations that use a combination of software and hardware.

FIG. 11 is an example of an architecture for a computing environment 1100 for a digital assistant implemented with generative artificial intelligence in accordance with various embodiments. As illustrated in FIG. 11, an infrastructure and various services and features can be used to enable a user to interact with a digital assistant (e.g., digital assistant 115a described with respect to FIG. 1) based at least in part on a series of prompts such as a conversation. The following is a detailed walkthrough of a conversation flow and the role and responsibility of the components, services, models, and the like of the computing environment 1100 within the conversation flow. In this walkthrough, it is assumed that a user “David” is interested in making a change to his 401k contribution, and in an utterance 1102, David provides the following input to the digital assistant: Hi, how are you, I want to make a change to my 401k contribution.

The utterance 1102 can be communicated to the digital assistant (e.g., via text dialogue box or microphone) and provided as input to an input pipeline 1108. The input pipeline 1108 is used by the digital assistant to create an execution plan 1110 that identifies one or more agents to address the request in the utterance 1102 and one or more actions for the one or more agents to execute for responding to the request. A two-step approach can be taken via the input pipeline 1108 to generate the execution plan 1110. First, a search 1112 can be performed to identify a list of candidate agents. The search 1112 comprises running a query on indices 1113 of a context and memory store 1114 based on the utterance 1102. In some examples, and as indicated in FIG. 11, the search 1112 for candidate agents in the context and memory store 1114 may be performed by a routing, planning, and dialog engine of the input pipeline 1108. In some instances, the search 1112 is a semantic search performed using words from the utterance 1102. The semantic search uses NLP and optionally machine learning techniques to understand the meaning of the utterance 1102 and retrieve relevant information from the context and memory store 1114. In contrast to traditional keyword-based searches, which rely on exact matches between the words in the query and the data in the context and memory store 1114, a semantic search takes into account the relationships between words, the context of the query, synonyms, and other linguistic nuances. This allows the digital assistant to provide more accurate and contextually relevant results, making it more effective in understanding the user's intent in the utterance 1102.

The context and memory store 1114 is implemented using a data framework for connecting external data to LLMs 1116 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 1117 associated with the digital assistant and its agents 1118 (e.g., 1118a and 1118b). The artifacts 1117 for the digital assistant include information on the general capabilities of the digital assistant and specific information concerning the capabilities of each of the agents 1118 (e.g., actions 220 described with respect to FIG. 2) available to the digital assistant (e.g., agent artifacts 205 described with respect to FIG. 2). In some instances, the data further includes metadata extracted from assets 1119 associated with the digital assistant and its agents 1118 (e.g., 1118a and 1118b). The assets 1119 may be resources, such as APIs 1120, files and/or documents 1122, data stores 1123, and the like, available to the agents 1118 for the execution of actions (e.g., actions 1125a, 1125b, and 1125c). The data is indexed in the context and memory store 1114 as indices 1113, which are data structures that provide a fast and efficient way to look up and retrieve specific data records within the data. Consequently, the context and memory store 1114 provides a searchable comprehensive record of the capabilities of all agents and associated assets that are available to the digital assistant for responding to the request.

The results of the search 1112 include a list of candidate agents that are not just available to the digital assistant for responding to the request but also potentially capable of facilitating the generation of a response to the utterance 1102. The list of candidate agents includes the metadata (e.g., metadata extracted from artifacts 1117 and assets 1119) from the context and memory store 1114 that is associated with each of the candidate agents. The list can be limited to a predetermined number of candidate agents (e.g., top 10) that satisfy the query or can include all agents that satisfy the query. The list of candidate agents with associated metadata is appended to the utterance 1102 to generate an input prompt 1127 for the LLM 1116. In some instances, context 1129 concerning the utterance 1102 are additionally appended to the list of candidate agents and the utterance 1102. The context 1129 is retrievable from the context and memory store 1114 and includes user session information, dialog state, conversation or contextual history, user information, or any combination thereof. The search 1112 can advantageously filter out agents that are unlikely to be capable of facilitating the generation of a response to the utterance 1102. This filter ensures that the number of tokens (e.g., word tokens) generated from the input prompt 1127 remains under a maximum token limit or context limit set for the LLM 1116. Token limits represent the maximum amount of text that can be inputted into an LLM. This limit is of a technical nature and arises due to computational constraints, such as memory and processing resources, and thus makes certain that the LLMs are capable of taking the input prompt as input.

The second step of the two-step approach is for the LLM 1116 to generate an execution plan 1110 based on the input prompt 1127. The LLM 1116 has a deep generative model architecture (e.g., a reversible or autoregressive architecture with) for generating the execution plan 1110. In some instances, the LLM 1116 has over 100 billion parameters and generates the execution plan 1110 using autoregressive language modeling within a transformer architecture, allowing the LLM 1116 to capture complex patterns and dependencies in the input prompt 1127. The LLM's 1116 ability to generate the execution plan 1110 is a result of its training on diverse and extensive textual data, enabling the LLM to understand human language across a wide range of contexts. During training, the LLM 1116 learns to predict the next word in a sequence given the context of the preceding words. This process involves adjusting the model's parameters (weights and biases) based on the errors between its predictions and the actual next words in the training data. When the LLM 1116 receives an input such as the input prompt 1127, the LLM 1116 tokenizes the text into smaller units such as words or sub-words. Each token is then represented as a vector in a high-dimensional space. The LLM 1116 processes the input sequence token by token, maintaining an internal representation of context. The LLM's 1116 attention mechanism allows it to weigh the importance of different tokens in the context of generating the next word. For each token in the vocabulary, the LLM 1116 calculates a probability distribution based on its learned parameters. This probability distribution represents the likelihood of each token being the next word given the context. To generate the execution plan 1110, the LLM 1116 samples a token from the calculated probability distribution. The sampled token becomes the next word in the generated sequence. This process is repeated iteratively, with each newly generated token influencing the context for generating the subsequent token. The LLM 1116 can continue generating tokens until a predefined length or stopping condition is reached.

In some instances, as illustrated in FIG. 11, the LLM 1116 may not be able to generate a complete execution plan 1110 because it is missing information such as if more information is required to determine an appropriate agent for the response, execute one or more actions, or the like. In this particular instance, the LLM 1116 has determine that in order to change the 401k contribution as request by the user, it is necessary to understand whether the user would like to change the contribution by a percentage or certain currency amount. In order to obtain this information, the LLM 1116 (or another LLM such as LLM 1136) generates end-user response 1135 (I'm doing good. Would you like to change your contribution by percentage or amount?[Percentage][Amount]) to the input prompt 1127 that can obtain the missing information such that the LLM 1116 is able to generate a complete execution plan 1110. In some instances, the response may be rendered within a dialogue box of a GUI having one or more GUI elements allowing for an easier response by the user. In other instances, the response may be rendered within a dialogue box of a GUI allowing for the user to reply using the dialogue box (or alternative means such as a microphone). In this particular instance, the user responds with an additional query 1138 (What is my current 401k Contribution?Also, can you tell me the contribution limit?) to gather additional information such that the user can reply to the response 1135. The subsequent response—additional query 1138—is input into the input pipeline 1108 and the same processes described above with respect to utterance 1102 are executed but this time with the context of the prior utterances/replies (e.g., utterance 1102 and response 1135) from the user's conversation with the digital assistant. This time, as illustrated in FIG. 11, the LLM 1116 is able to generate a complete execution plan 1110 because it has all the information it needs.

The execution plan 1110 includes an ordered list of agents and/or actions that can be used and/or executed to sufficiently respond to the request such as the additional query 1138. For example, and as illustrated in FIG. 11, the execution plan 1110 can be an ordered list that includes a first agent 1142a capable of executing a first action 1144a via an associated asset and a second agent 1142b capable of executing a second action 1144b via an associated asset. The agents, and by extension the actions, may be ordered to cause the first action 1144a to be executed by the first agent 1142a prior to causing the second action 1144b to be executed by the second agent 1142b. In some instances, the execution plan 1110 may be ordered based on dependencies indicated by the agents and/or actions included in the execution plan 1110. For example, if executing the second agent 1142b is dependent on, or otherwise requires, an output generated by the first agent 1142a executing the first action 1144a, then the execution plan 1110 may order the first agent 1142a and the second agent 1142b to comply with the dependency. As should be understood, other examples of dependencies are possible.

The execution plan 1110 is then transmitted to an execution engine 1150 for implementation. The execution engine 1150 includes a number of engines, including a natural language-to-programming language translator 1152, a knowledge engine 1154, an API engine 1156, a prompt engine 1158, and the like. for executing the actions of agents and implementing the execution plan 1110. For example, the natural language-to-programming language translator 1152, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 1119 such as data stores 1123 to execute actions and/or obtain data or information. The knowledge engine 1154 may be used by an agent to obtain data or information from the context and memory store 1114 or an asset 1119 such as files/documents 1122. The API engine 1156 may be used by an agent to call an API 1120 and interface with an application such as retirement fund account management application to execute actions and/or obtain data or information. The prompt engine 1158 may be used by an agent to generate a prompt for input into an LLM such as an LLM in the context and memory store 1114 or an asset 1119 to execute actions and/or obtain data or information.

The execution engine 1150 implements the execution plan 1110 by running each agent and executing each action in order based on the ordered list of agents and/or actions using the appropriate engine(s). To facilitate this implementation, the execution engine 1150 is communicatively connected (e.g., via a public and/or provue network) with the agents (e.g., 1142a, 1142b, etc.), the context and memory store 1114, and the assets 1119. For example, as illustrated in FIG. 11, when the execution engine 1150 implements the execution plan 1110, it will first execute the agent 1142a and action 1144a using API engine 1156 to call the API 1120 and interface with a retirement fund account management application to retrieve the user's current 401k contribution. Subsequently, the execution engine 1150 can execute the agent 1142b and action 1144b using knowledge engine 1154 to retrieve knowledge on 401k contribution limits. In some instances, the knowledge is retrieved by knowledge engine 1154 from the assets 1119 (e.g., files/documents 1122). In other instances (as in this particular instance), the knowledge is retrieved by knowledge engine 1154 from the context and memory store 1114. Knowledge retrieval and action execution using the context and memory store 1114 may be implemented using various techniques including internal task mapping and/or machine learning models such as additional LLM models. For example, the query and associated agent for “What is 401k contribution limit” may be mapped to a ‘semantic search’ knowledge task type for searching the indices 1113 within the context and memory store 1114 for a response to a given query. By way of another example, a request such as “Can you summarize the key points relating to 401k contribution” can be or include a ‘summary’ knowledge task type that may be mapped to a different index within the context and memory store 1114 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 1114 are optimized to the various task or action types.

The result of implementing the execution plan 1110 is output data 1169 (e.g., results of actions, data, information, etc.), which is transmitted to an output pipeline 1170 for generating end-user responses 1172. For example, the output data 1169 from the assets 1119 (knowledge, API, dialog history, etc.) and relevant information from the context and memory store 1114 can be transmitted to the output pipeline 1170. The output data 1169 is appended to the utterance 1102 to generate an output prompt 1174 for input to the LLM 1136. In some instances, context 1129 concerning the utterance 1102 are additionally appended to the output data 1169 and the utterance 1102. The context 1129 is retrievable from the context and memory store 1114 and includes user session information, dialog state, conversation or contextual history, user information, or any combination thereof. The LLM 1136 generates responses 1172 based on the output prompt 1174. In some instances, the LLM 1136 is the same or similar model as LLM 1116. In other instances, the LLM 1136 different from LLM 1116 (e.g., trained on a different set of data, a different architecture, trained for a one or more different tasks, etc.). In either instance, the LLM 1136 has a deep generative model architecture (e.g., a reversible or autoregressive architecture with) for generating the responses 1172 using similar training and generative processes described above with respect to LLM 1116. In some instances, the LLM 1136 has over 100 billion parameters and generates the responses 1172 using autoregressive language modeling within a transformer architecture, allowing the LLM 1136 to capture complex patterns and dependencies in the output prompt 1174.

In some instances, the end-user responses 1172 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 1170 transmits the responses 1172 to the end user such as via a user device or interface. In some instances, the responses 1172 are rendered within a dialogue box of a GUI allowing for the user to view and reply using the dialogue box (or alternative means such as a microphone). In other instances, the responses 1172 are rendered within a dialogue box of a GUI having one or more GUI elements allowing for an easier response by the user. In this particular instance, a first response 1172 (What is my current 401k Contribution?Also, can you tell me the contribution limit?) to the additional query 11118 is rendered within the dialogue box of a GUI. Additionally, in order to follow-up on obtaining information still required for the initial utterance 1102, the LLM 1136 generates another response 1172 prompting the user for the missing information (Would you like to change your contribution by percentage or amount?[Percentage][Amount]).

While the embodiment of computing environment 1100 in FIG. 11 illustrates the digital assistant interacting in a particular conversation flow, this is not intended to be limiting and is merely provided to facilitate a better understanding of the role and responsibility of the components, services, models, and the like of the computing environment 1100 within the conversation flow.

Flowcharts of Processes for Configuring and Testing an Agent that can be Used by a Digital Assistant

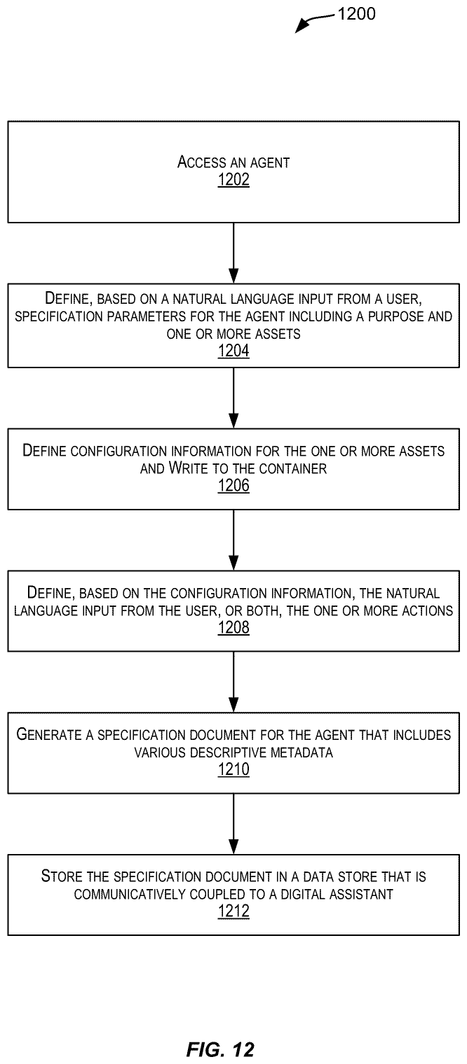

FIG. 12 is a flowchart of a process 1200 for configuring an agent for use by a digital assistant as part of an execution plan to respond to a natural language utterance input of an end user of the digital assistant and to execute one or more actions that can be used to generate a response to the natural language utterance. Agent configuration may be accomplished by, for example, use of an agent composition tool of a suite of tools of a digital assistant builder platform (DABP). The agent composition tool may present a user with a user interface that can facilitate creation and configuration of agents using natural language inputs.

As indicated at 1202, the process may initially include accessing an agent. At 1204, specification parameters can be defined for the agent. The specification parameters can be based on natural language input from a user. The specification parameters can include, for example, an agent identifier/name, a purpose of the agent, and an identification of one or more assets for implementing the purpose of the agent. Assets may include, for example, API specifications and knowledge documents that can be used by the agent to execute the one or more actions. The agent may be provided with the location of the assets. The location may be a URL, a document identifier when a knowledge document has been uploaded into an instance-level document store, etc. An API specification asset can include rules to facilitate agent interaction with another application. A knowledge document asset can provide the agent with rules, instructions, restrictions, or other parameters for guiding or governing performance of the agent actions.

At 1206, configuration information for the one or more assets may be defined. Defining configuration information for the one or more assets can involve accessing a specification, such as an API specification or a specification in the form of a knowledge document, and thereafter extracting configuration information for each asset from a corresponding asset specification. The configuration information may be written into the container, such as into a configuration file(s) within the container.

At 1208, the one or more actions for the agent may be defined. The one or more actions may be defined based on the defining of the configuration information, based on the natural language input from the user, or both. An action can be an explicit action that is authored by a user using natural language. For example, a user may define agent actions by typing action information into one or more fields of a user interface of the provided by the agent composition tool. Alternatively, an action may be an implicit action that is automatically created when an asset is imported into the container.

At 1210, a specification document may be generated for the agent. Generating the specification document may comprise acquiring metadata from the agent. The metadata may be associated with the specification parameters, the one or more assets, the one or more actions, or any combination thereof. The metadata may be associated with an identifier of the agent. The metadata and the identifier may be written into the specification document.

At 1212, the generated specification document may be stored in a data store that is communicatively coupled to a digital assistant. In some examples, the data store can be a context and memory store. When the data store is a context and memory store, for example, agent specification documents may be indexed in one or more searchable indices that can provide a comprehensive record of the capabilities of all existing agents and the associated assets that are available to a digital assistant.

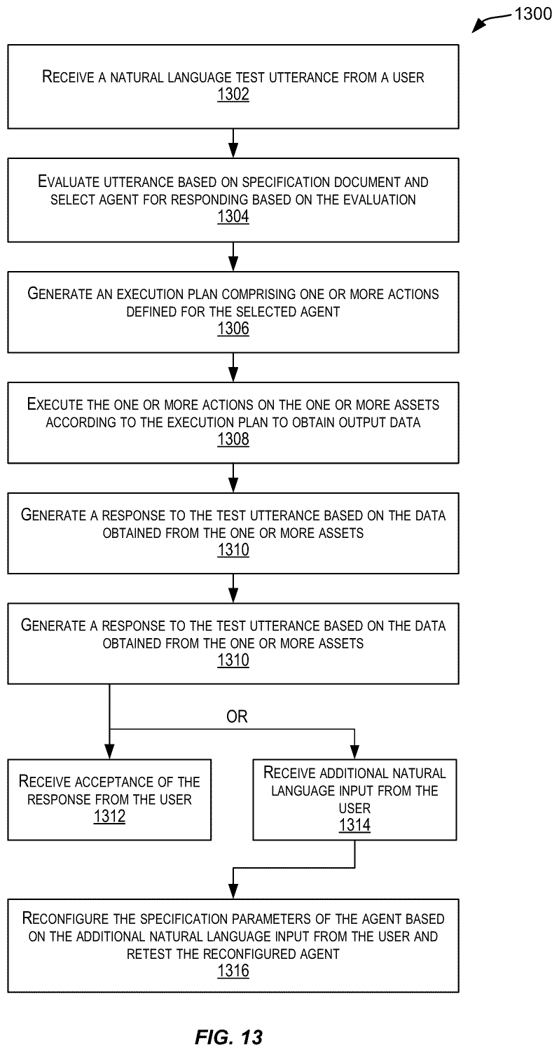

FIG. 13 is a flowchart of a process 1300 for testing the functionality of a configured agent. In some examples, the testing may be an interactive process performed between a user and a generative artificial intelligence model, which may be the previously described prompt-based agent composition tool. The testing can be an interactive process. For example, at 1302, the interactive testing process may begin by receiving a natural language test utterance from a user.

At 1304, the natural language utterance may be evaluated based on the specification document, and an agent may be selected for use in responding to the test utterance based on the evaluation. More particularly, the agent may be selected based on the description metadata and the identifier associated with the specification document.

At 1306, an execution plan can be generated for responding to the natural language utterance. The execution plan can include one or more actions defined for the agent.

At 1308, the one or more actions can be executed based on the execution plan and the configuration information for the one or more assets. Executing the one or more actions obtains output data. For example, asset data may be extracted from specifications associated with individual assets of the agent. In some examples, executing the one or more actions of the agent on the one or more assets of the agent may call one or more APIs associated with the agent. In other examples, executing the one or more actions of the agent on the one or more assets of the agent may instead or additionally involve reading one or more knowledge documents associated with the agent.

At 1310 a response to the natural language utterance may be generated based on the output data obtained from the one or more assets. As indicated at 1312, the functionality of the agent to implement the purpose of the agent can be evaluated based on the generated response.

As indicated in 1312, in some cases, acceptance of the generated response and corresponding approval of the functionality of the agent may be received from the user. Alternatively, evaluation of the generated response to the natural language utterance may instead cause the user to determine that the functionality of the agent is unacceptable. In such a case, the user may provide additional natural language input related to a change in the specification parameters of the agent, as indicated at 1314. A user may also provide additional natural language input concerning a change to the specification parameters or the one or more actions prior to generation of the response to the test utterance. For example, the user may provide additional natural language input after selection of the agent, running of the agent, or obtaining data from the one or more assets of the agent. At 1316, when the user provides additional natural language input concerning a change to the specification parameters or the one or more actions, the agent can be reconfigured based on the user-indicated changes to the specification parameters or the one or more actions and the reconfigured agent may be retested for proper functionality.

Flowcharts of Processes Involving a Digital Assistant that can be Implemented with Generative Artificial Intelligence

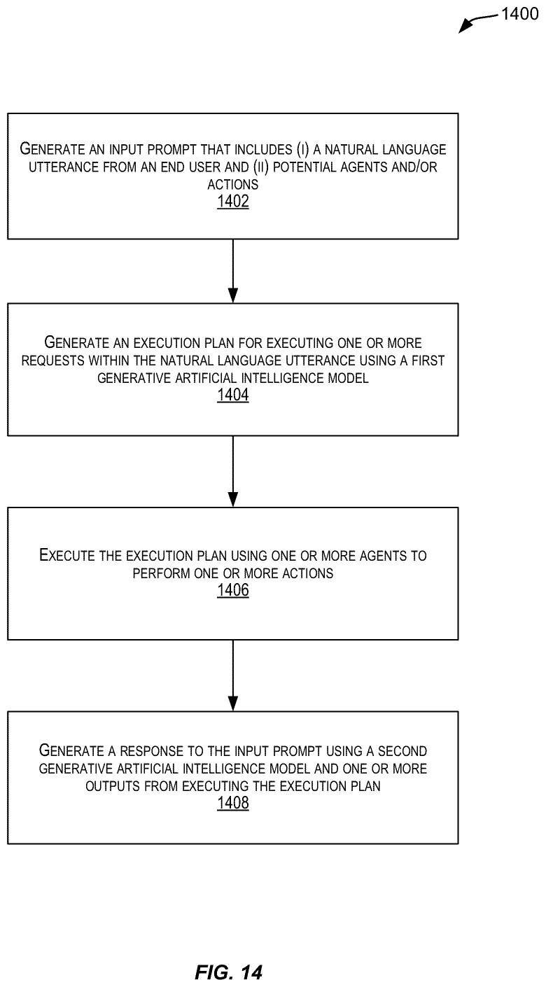

FIG. 14 is a flowchart of a process 1400 for generating a response to user input using a digital assistant that can be implemented using generative artificial intelligence in according with various embodiments. The processing depicted in FIG. 14 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 14 and described below is intended to be illustrative and non-limiting. Although FIG. 14 illustrates the various processing steps occurring in a particular sequence or order, this is not intended to be limiting. In certain alternative embodiments, the steps may be performed in some different order or some steps may also be performed in parallel. In certain embodiments, the processing depicted in FIG. 14 may be performed by one or more of the components, computing devices, services, or the like, such as the digital assistant, the first and/or second generative artificial intelligence model (LLMs), etc., illustrated and described with respect to FIGS. 1-3.

At 1402, an input prompt is generated based on a natural language utterance received from a user of a digital assistant. The input prompt may be generated by a digital assistant for input into a first generative artificial intelligence model (e.g., LLM).

In some instances, the input prompt is generated based on the natural language utterance received from a user of the digital assistant and one or more candidate agents and associated actions identified from a data store of available agents and actions.

In some instances, generating the input prompt comprises executing, using the natural language utterance, a sematic search on descriptions associated with the available agents and actions in the data store, identifying, based on the semantic search, the one or more potential agents and associated actions, and generating a natural language representation for the input prompt by appending one or more potential agents and associated actions to the natural language utterance.

In some instances, the natural language utterance is a continuation or subsequent utterance within a conversation, and the input prompt further comprises: (iii) conversation history and actions executed prior to the natural language utterance. In some instances, generating the input prompt comprises accessing the conversation history and the actions executed prior to the natural language utterance, and generating the natural language representation for the input prompt by appending the one or more potential agents, the associated actions, and the conversation history and the actions executed prior to the natural language utterance to the natural language utterance.

In some instances, the one or more agents are a plurality of agents and the one or more actions are a plurality of actions. A first subset of the plurality of agents and the plurality of actions may be in a first state and a second subset of the plurality of agents and the plurality of actions may be in a second state. The first state is a ready for execution state and the second state is not ready for execution state where additional information is required prior to execution of one or more actions within the second subset of the plurality of agents and the plurality of actions.

At 1404, an execution plan is generated for executing one or more requests represented by the natural language utterance. The execution plan is generated by a first generative artificial intelligence model using the input prompt from 1402.

In some instances, generating the execution plan comprises determining, based on the one or more potential agents and associated actions, one or more agents and one or more actions associated with the one or more agents that can service the one or more requests, and generating a structured output for the execution plan by creating an ordered list that comprises one or more actions (and optionally the one or more agents associated with the actions) for executing the one or more requests.

At 1406, the execution plan is executed to perform the one or more actions using one or more agents. In some instances, executing the execution plan comprises triggering performance of the one or more actions by the one or more agents, and receiving one or more outputs from performance of the one or more actions by the one or more agents.

In some instances, executing the execution plan further comprises accessing contextual information that is needed by at least one of the one or more agents for performing at least one of the one or more actions, and triggering the performance of the one or more actions comprises forwarding one or more requests for performance of the one or more actions to the one the one or more agents. A request of the one or more requests being forwarded for performance of the at least one of the one or more actions may include the contextual information.

At 1408, a response to the natural language utterance is generated by a second generative artificial intelligence model using the one or more outputs. The second generative artificial intelligence model may be similar or identical to, or may be different than, the first generative artificial intelligence model.

In some instances, the one or more agents are a plurality of agents, the one or more actions are a plurality of actions, and the one or more requests are a plurality of requests, and generating the execution plan further comprises determining whether one or more dependencies exist between the plurality of actions, and when the one or more dependencies exist, the ordered list is created to comprise the plurality agents, the plurality of actions for executing the one or more requests, and an indication of the one or more dependencies, when the execution plan comprises the indication of the one or more dependencies, the performance of the one or more actions by the one or more agents is triggered via serial processing, when the execution plan does not comprise the indication of the one or more dependencies, the performance of the one or more actions by the one or more agents is triggered via parallel processing, and the response is an aggregate response comprising a plurality of responses to the plurality of requests within the natural language utterance.

In some instances, the natural language utterance is a continuation or subsequent utterance within a conversation, and the response to the natural language utterance is generated by the second generative artificial intelligence model using the one or more output, the natural language utterance, and a conversation history for the conversation.

In some instances, the response is communicated to the user.

### Illustrative Systems

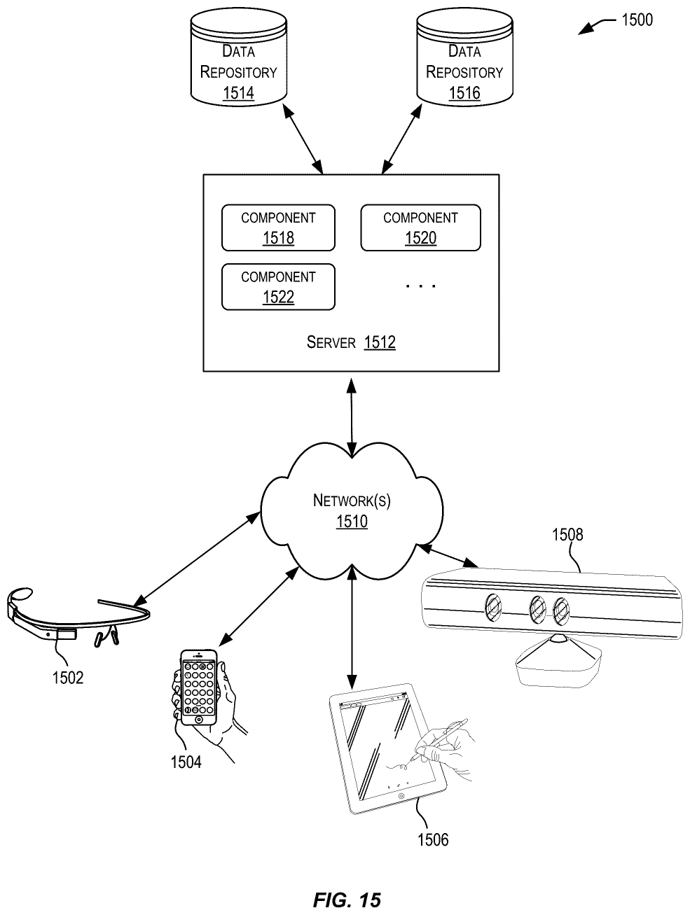

FIG. 15 depicts a simplified diagram of a distributed system 1500. In the illustrated example, distributed system 1500 includes one or more client computing devices 1502, 1504, 1506, and 1508, coupled to a server 1512 via one or more communication networks 1510. Clients computing devices 1502, 1504, 1506, and 1508 may be configured to execute one or more applications.

In various examples, server 1512 may be adapted to run one or more services or software applications that enable one or more embodiments described in this disclosure. In certain examples, server 1512 may also provide other services or software applications that may include non-virtual and virtual environments. In some examples, these services may be offered as web-based or cloud services, such as under a Software as a Service (SaaS) model to the users of client computing devices 1502, 1504, 1506, and/or 1508. Users operating client computing devices 1502, 1504, 1506, and/or 1508 may in turn utilize one or more client applications to interact with server 1512 to utilize the services provided by these components.

In the configuration depicted in FIG. 15, server 1512 may include one or more components 1518, 1520 and 1522 that implement the functions performed by server 1512. These components may include software components that may be executed by one or more processors, hardware components, or combinations thereof. It should be appreciated that various different system configurations are possible, which may be different from distributed system 1500. The example shown in FIG. 15 is thus one example of a distributed system for implementing an example system and is not intended to be limiting.

Users may use client computing devices 1502, 1504, 1506, and/or 1508 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 15 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 1510 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1510 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1512 may include one or more virtual machines running virtual operating systems, or other computing architectures involving virtualization such as one or more flexible pools of logical storage devices that may be virtualized to maintain virtual storage devices for the server. In various examples, server 1512 may be adapted to run one or more services or software applications that provide the functionality described in the foregoing disclosure.

The computing systems in server 1512 may run one or more operating systems including any of those discussed above, as well as any commercially available server operating system. Server 1512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 1512 may include one or more applications to analyze and consolidate data feeds and/or event updates received from users of client computing devices 1502, 1504, 1506, and 1508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1512 may also include one or more applications to display the data feeds and/or real-time events via one or more display devices of client computing devices 1502, 1504, 1506, and 1508.

Distributed system 1500 may also include one or more data repositories 1514, 1516. These data repositories may be used to store data and other information in certain examples. For example, one or more of the data repositories 1514, 1516 may be used to store information such as information related to chatbot performance or generated models for use by chatbots used by server 1512 when performing various functions in accordance with various embodiments. Data repositories 1514, 1516 may reside in a variety of locations. For example, a data repository used by server 1512 may be local to server 1512 or may be remote from server 1512 and in communication with server 1512 via a network-based or dedicated connection. Data repositories 1514, 1516 may be of different types. In certain examples, a data repository used by server 1512 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 1514, 1516 may also be used by applications to store application data. The data repositories used by applications may be of different types such as, for example, a key-value store repository, an object store repository, or a general storage repository supported by a file system.

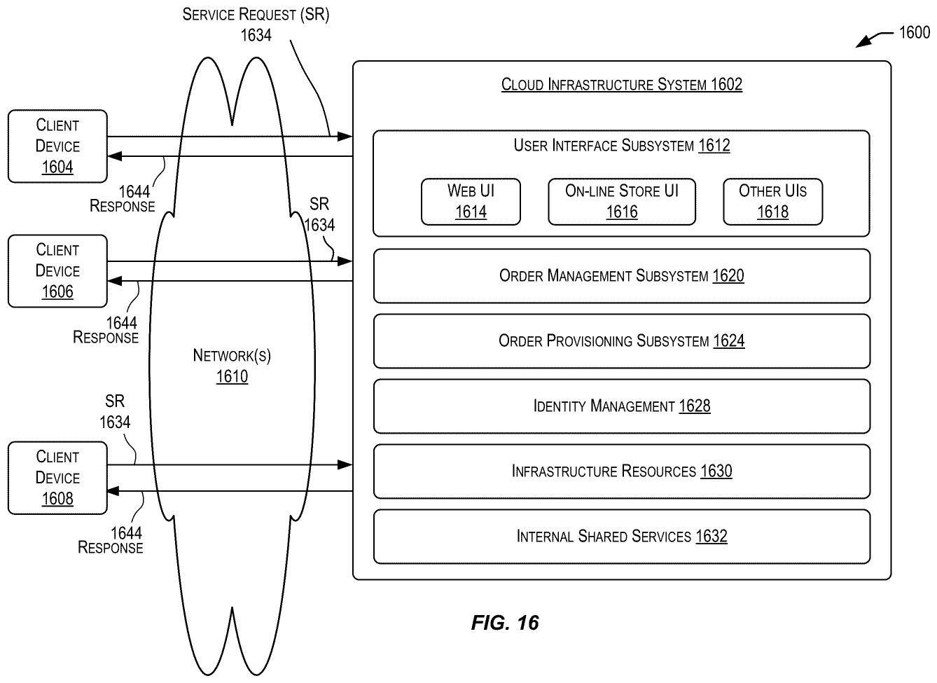

In certain examples, the functionalities described in this disclosure may be offered as services via a cloud environment. FIG. 16 is a simplified block diagram of a cloud-based system environment in which various services may be offered as cloud services in accordance with certain examples. In the example depicted in FIG. 16, cloud infrastructure system 1602 may provide one or more cloud services that may be requested by users using one or more client computing devices 1604, 1606, and 1608. Cloud infrastructure system 1602 may comprise one or more computers and/or servers that may include those described above for server 1512. The computers in cloud infrastructure system 1602 may be organized as general purpose computers, specialized server computers, server farms, server clusters, or any other appropriate arrangement and/or combination.

Network(s) 1610 may facilitate communication and exchange of data between clients 1604, 1606, and 1608 and cloud infrastructure system 1602. Network(s) 1610 may include one or more networks. The networks may be of the same or different types. Network(s) 1610 may support one or more communication protocols, including wired and/or wireless protocols, for facilitating the communications.

The example depicted in FIG. 16 is only one example of a cloud infrastructure system and is not intended to be limiting. It should be appreciated that, in some other examples, cloud infrastructure system 1602 may have more or fewer components than those depicted in FIG. 16, may combine two or more components, or may have a different configuration or arrangement of components. For example, although FIG. 16 depicts three client computing devices, any number of client computing devices may be supported in alternative examples.

The term cloud service is generally used to refer to a service that is made available to users on demand and via a communication network such as the Internet by systems (e.g., cloud infrastructure system 1602) of a service provider. Typically, in a public cloud environment, servers and systems that make up the cloud service provider's system are different from the customer's own on-premise servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 1602 may provide one or more cloud services using different models such as under a Software as a Service (SaaS) model, a Platform as a Service (PaaS) model, an Infrastructure as a Service (IaaS) model, and others, including hybrid service models. Cloud infrastructure system 1602 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 1602. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 1602. Cloud infrastructure system 1602 then performs processing to provide the services requested in the customer's subscription order. For example, a user may use utterances to request the cloud infrastructure system to take a certain action (e.g., an intent), as described above, and/or provide services for a chatbot system as described herein. Cloud infrastructure system 1602 may be configured to provide one or even multiple cloud services.

Cloud infrastructure system 1602 may provide the cloud services via different deployment models. In a public cloud model, cloud infrastructure system 1602 may be owned by a third party cloud services provider and the cloud services are offered to any general public customer, where the customer may be an individual or an enterprise. In certain other examples, under a private cloud model, cloud infrastructure system 1602 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 1602 and the services provided may be shared by several organizations in a related community. Various other models such as hybrids of the above mentioned models may also be used.

Client computing devices 1604, 1606, and 1608 may be of different types (such as client computing devices 1502, 1504, 1506, and 1508 depicted in FIG. 15) and may be capable of operating one or more client applications. A user may use a client device to interact with cloud infrastructure system 1602, such as to request a service provided by cloud infrastructure system 1602. For example, a user may use a client device to request information or action from a chatbot as described in this disclosure.

In some examples, the processing performed by cloud infrastructure system 1602 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 1602 for generating and training one or more models for a chatbot system. The data used for this analysis may include structured data (e.g., data stored in a database or structured according to a structured model) and/or unstructured data (e.g., data blobs (binary large objects)).

As depicted in the example in FIG. 16, cloud infrastructure system 1602 may include infrastructure resources 1630 that are utilized for facilitating the provision of various cloud services offered by cloud infrastructure system 1602. Infrastructure resources 1630 may include, for example, processing resources, storage or memory resources, networking resources, and the like. In certain examples, the storage virtual machines that are available for servicing storage requested from applications may be part of cloud infrastructure system 1602. In other examples, the storage virtual machines may be part of different systems.

In certain examples, to facilitate efficient provisioning of these resources for supporting the various cloud services provided by cloud infrastructure system 1602 for different customers, the resources may be bundled into sets of resources or resource modules (also referred to as “pods”). Each resource module or pod may comprise a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1602 may itself internally use services 1632 that are shared by different components of cloud infrastructure system 1602 and which facilitate the provisioning of services by cloud infrastructure system 1602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1602 may comprise multiple subsystems. These subsystems may be implemented in software, or hardware, or combinations thereof. As depicted in FIG. 16, the subsystems may include a user interface subsystem 1612 that enables users or customers of cloud infrastructure system 1602 to interact with cloud infrastructure system 1602. User interface subsystem 1612 may include various different interfaces such as a web interface 1614, an online store interface 1616 where cloud services provided by cloud infrastructure system 1602 are advertised and are purchasable by a consumer, and other interfaces 1618. For example, a customer may, using a client device, request (service request 1634) one or more services provided by cloud infrastructure system 1602 using one or more of interfaces 1614, 1616, and 1618. For example, a customer may access the online store, browse cloud services offered by cloud infrastructure system 1602, and place a subscription order for one or more services offered by cloud infrastructure system 1602 that the customer wishes to subscribe to. The service request may include information identifying the customer and one or more services that the customer desires to subscribe to. For example, a customer may place a subscription order for a service offered by cloud infrastructure system 1602. As part of the order, the customer may provide information identifying a chatbot system for which the service is to be provided and optionally one or more credentials for the chatbot system.

In certain examples, such as the example depicted in FIG. 16, cloud infrastructure system 1602 may comprise an order management subsystem (OMS) 1620 that is configured to process the new order. As part of this processing, OMS 1620 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 1620 may then invoke the order provisioning subsystem (OPS) 1624 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 1624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 1602 as part of the provisioning process. Cloud infrastructure system 1602 may generate an application ID and select a storage virtual machine for an application from among storage virtual machines provided by cloud infrastructure system 1602 itself or from storage virtual machines provided by other systems other than cloud infrastructure system 1602.

Cloud infrastructure system 1602 may send a response or notification 1644 to the requesting customer to indicate when the requested service is now ready for use. In some instances, information (e.g., a link) may be sent to the customer that enables the customer to start using and availing the benefits of the requested services. In certain examples, for a customer requesting the service, the response may include a chatbot system ID generated by cloud infrastructure system 1602 and information identifying a chatbot system selected by cloud infrastructure system 1602 for the chatbot system corresponding to the chatbot system ID.

Cloud infrastructure system 1602 may provide services to multiple customers. For each customer, cloud infrastructure system 1602 is responsible for managing information related to one or more subscription orders received from the customer, maintaining customer data related to the orders, and providing the requested services to the customer. Cloud infrastructure system 1602 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 1602 may provide services to multiple customers in parallel. Cloud infrastructure system 1602 may store information for these customers, including possibly proprietary information. In certain examples, cloud infrastructure system 1602 comprises an identity management subsystem (IMS) 1628 that is configured to manage customer information and provide the separation of the managed information such that information related to one customer is not accessible by another customer. IMS 1628 may be configured to provide various security-related services such as identity services, such as information access management, authentication and authorization services, services for managing customer identities and roles and related capabilities, and the like.

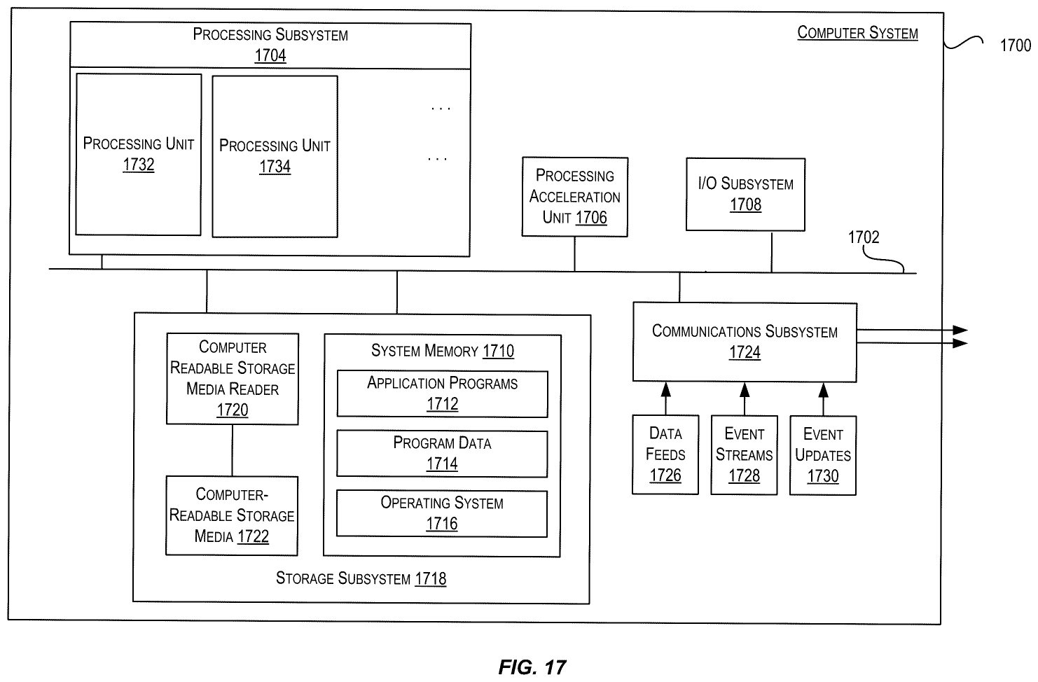

FIG. 17 illustrates an example of computer system 1700. In some examples, computer system 1700 may be used to implement any of the digital assistant or chatbot systems within a distributed environment, and various servers and computer systems described above. As shown in FIG. 17, computer system 1700 includes various subsystems including a processing subsystem 1704 that communicates with a number of other subsystems via a bus subsystem 1702. These other subsystems may include a processing acceleration unit 1706, an I/O subsystem 1708, a storage subsystem 1718, and a communications subsystem 1724. Storage subsystem 1718 may include non-transitory computer-readable storage media including computer-readable storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative examples of the bus subsystem may utilize multiple buses. Bus subsystem 1702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 1704 controls the operation of computer system 1700 and may comprise one or more processors, application specific integrated circuits (ASICs), or field programmable gate arrays (FPGAs). The processors may include be single core or multicore processors. The processing resources of computer system 1700 may be organized into one or more processing units 1732, 1734, etc. A processing unit may include one or more processors, one or more cores from the same or different processors, a combination of cores and processors, or other combinations of cores and processors. In some examples, processing subsystem 1704 may include one or more special purpose co-processors such as graphics processors, digital signal processors (DSPs), or the like. In some examples, some or all of the processing units of processing subsystem 1704 may be implemented using customized circuits, such as application specific integrated circuits (ASICs), or field programmable gate arrays (FPGAs).

In some examples, the processing units in processing subsystem 1704 may execute instructions stored in system memory 1710 or on computer-readable storage media 1722. In various examples, the processing units may execute a variety of programs or code instructions and may maintain multiple concurrently executing programs or processes. At any given time, some or all of the program code to be executed may be resident in system memory 1710 and/or on computer-readable storage media 1722 including potentially on one or more storage devices. Through suitable programming, processing subsystem 1704 may provide various functionalities described above. In instances where computer system 1700 is executing one or more virtual machines, one or more processing units may be allocated to each virtual machine.

In certain examples, a processing acceleration unit 1706 may optionally be provided for performing customized processing or for off-loading some of the processing performed by processing subsystem 1704 so as to accelerate the overall processing performed by computer system 1700.

I/O subsystem 1708 may include devices and mechanisms for inputting information to computer system 1700 and/or for outputting information from or via computer system 1700. In general, use of the term input device is intended to include all possible types of devices and mechanisms for inputting information to computer system 1700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 1700 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1718 provides a repository or data store for storing information and data that is used by computer system 1700. Storage subsystem 1718 provides a tangible non-transitory computer-readable storage medium for storing the basic programming and data constructs that provide the functionality of some examples. Storage subsystem 1718 may store software (e.g., programs, code modules, instructions) that when executed by processing subsystem 1704 provides the functionality described above. The software may be executed by one or more processing units of processing subsystem 1704. Storage subsystem 1718 may also provide authentication in accordance with the teachings of this disclosure.

Storage subsystem 1718 may include one or more non-transitory memory devices, including volatile and non-volatile memory devices. As shown in FIG. 17, storage subsystem 1718 includes a system memory 1710 and a computer-readable storage media 1722. System memory 1710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1700, such as during start-up, may typically be stored in the ROM. The RAM typically contains data and/or program modules that are presently being operated and executed by processing subsystem 1704. In some implementations, system memory 1710 may include multiple different types of memory, such as static random access memory (SRAM), dynamic random access memory (DRAM), and the like.

By way of example, and not limitation, as depicted in FIG. 17, system memory 1710 may load application programs 1712 that are being executed, which may include various applications such as Web browsers, mid-tier applications, relational database management systems (RDBMS), etc., program data 1714, and an operating system 1716. By way of example, operating system 1716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1722 may store programming and data constructs that provide the functionality of some examples. Computer-readable storage media 1722 may provide storage of computer-readable instructions, data structures, program modules, and other data for computer system 1700. Software (programs, code modules, instructions) that, when executed by processing subsystem 1704 provides the functionality described above, may be stored in storage subsystem 1718. By way of example, computer-readable storage media 1722 may include non-volatile memory such as a hard disk drive, a magnetic disk drive, an optical disk drive such as a CD ROM, DVD, a Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 1718 may also include a computer-readable storage media reader 1720 that may further be connected to computer-readable storage media 1722. The computer-readable storage media reader 1720 may receive and be configured to read data from a memory device such as a disk, a flash drive, etc.

In certain examples, computer system 1700 may support virtualization technologies, including but not limited to virtualization of processing and memory resources. For example, computer system 1700 may provide support for executing one or more virtual machines. In certain examples, computer system 1700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1700. Accordingly, multiple operating systems may potentially be run concurrently by computer system 1700.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to establish a communication channel to one or more client devices via the Internet for receiving and sending information from and to the client devices. For example, when computer system 1700 is used to implement digital assistant 106 depicted in FIG. 1, the communication subsystem may be used to communicate with a chatbot system selected for an application.

Communication subsystem 1724 may support both wired and/or wireless communication protocols. In certain examples, communications subsystem 1724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some examples, communications subsystem 1724 may provide wired network connectivity (e.g., Ethernet) in addition to or instead of a wireless interface.

Communication subsystem 1724 may receive and transmit data in various forms. In some examples, in addition to other forms, communications subsystem 1724 may receive input communications in the form of structured and/or unstructured data feeds 1726, event streams 1728, event updates 1730, and the like. For example, communications subsystem 1724 may be configured to receive (or send) unstructured data feeds 1726 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 1724 may be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1724 may also be configured to communicate data from computer system 1700 to other computer systems or networks. The data may be communicated in various different forms such as structured and/or unstructured data feeds 1726, event streams 1728, event updates 1730, and the like to one or more databases that may be in communication with one or more streaming data source computers coupled to computer system 1700.

Computer system 1700 may be one of various types, including a handheld portable device (e.g., an iPhone® cellular phone, an iPad© computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 1700 depicted in FIG. 17 is intended only as a specific example. Many other configurations having more or fewer components than the system depicted in FIG. 17 are possible. Based on the disclosure and teachings provided herein, it should be appreciate there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, subsystems, components or services are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
accessing a container defining an agent configurable to have one or more actions;
configuring the agent for use by a digital assistant, wherein the configuring comprises:
defining, based on natural language input from a user, specification parameters including an identification of the agent, a purpose of the agent, and identification of one or more assets for implementing the purpose,
defining configuration information for the one or more assets, and
defining the one or more actions based on the configuration information, the natural language input from the user, or both;
generating a specification document that characterizes the agent, wherein generating the specification document comprises: acquiring, from the agent, metadata associated with: the specification parameters, the one or more assets, the one or more actions, or any combination thereof, and writing the specification document to include the metadata and the identification of the agent; and
storing the specification document in a data store that is communicatively coupled to the digital assistant.

2. The computer-implemented method of claim 1, further comprising:
receiving, by a generative artificial intelligence model, a natural language utterance from the user; and
testing, by the generative artificial intelligence model using the natural language utterance, functionality of the agent to implement the purpose of the agent,
wherein configuring the agent is performed by the generative artificial intelligence model.

3. The computer-implemented method of claim 2, wherein the testing is an interactive process between the user and the generative artificial intelligence model, the interactive process comprising:
(i) evaluating the natural language utterance based on the specification document;
(ii) selecting the agent for use in responding to the natural language utterance based on evaluating the natural language utterance;
(iii) generating an execution plan comprising the one or more actions defined for the agent;
(iv) executing, based on the execution plan and the configuration information for the one or more assets, the one or more actions to obtain output data;
(v) generating a response to the natural language utterance based on the output data; and
(vi) evaluating, based on the response, the functionality of the agent to implement the purpose of the agent.

4. The computer-implemented method of claim 3, wherein the interactive process further comprises:
(vii) determining, based on evaluating the purpose of the agent, the functionality of the agent to implement the purpose of the agent is unacceptable;
(viii) in response to determining the functionality is unacceptable, receiving additional natural language input from the user concerning a change to the specification parameters;
(ix) reconfiguring the agent based on the change to the specification parameters; and
(x) reperforming steps (i)-(vi) of the interactive process.

5. The computer-implemented method of claim 1, wherein defining the configuration information for the one or more assets comprises:
accessing a specification for each of the one or more assets;
extracting the configuration information from the specification for each of the one or more assets; and
writing the configuration information into the container.

6. The computer-implemented method of claim 1, further comprising:
receiving a natural language utterance as a user input to the digital assistant; and
generating a response to the natural language utterance based on the specification document and the agent.

7. The computer-implemented method of claim 6, wherein generating the response comprises:
executing, using the natural language utterance, a search on specification documents in the data store, wherein the specification documents include the specification document for the agent;
identifying, based on the search, one or more candidate agents and associated actions for generating the response, wherein the one or more candidate agents include the agent;
generating an input prompt by combining metadata obtained from specification documents for the one or more candidate agents with the natural language utterance, wherein the metadata comprises the metadata written in the specification document for the agent;
generating, by a first generative artificial intelligence model and based on the input prompt, an execution plan for responding to the natural language utterance, wherein the execution plan includes an order list of actions comprising the one or more actions;
executing, based on the execution plan and the configuration information for the one or more assets, the one or more actions to obtain output data;
generating, using the output data, an output prompt for a second generative artificial intelligence model of the digital assistant, the second generative artificial intelligence model being the same or different from the first generative artificial intelligence model; and
generating, by the second generative artificial intelligence model and based on the output prompt, the response to the natural language utterance.

8. A system comprising:
one or more processors; and
one or more computer-readable media storing instructions which, when executed by the one or more processors, cause the system to perform operations comprising:
accessing a container defining an agent configurable to have one or more actions;
configuring the agent for use by a digital assistant, wherein the configuring comprises:
defining, based on natural language input from a user, specification parameters including an identification of the agent, a purpose of the agent, and identification of one or more assets for implementing the purpose,
defining configuration information for the one or more assets, and
defining the one or more actions based on the configuration information, the natural language input from the user, or both;
generating a specification document that characterizes the agent, wherein generating the specification document comprises: acquiring, from the agent, metadata associated with: the specification parameters, the one or more assets, the one or more actions, or any combination thereof, and writing the specification document to include the metadata and the identification of the agent; and
storing the specification document in a data store that is communicatively coupled to the digital assistant.

9. The system of claim 8, wherein the operations further comprise:
receiving, by a generative artificial intelligence model, a natural language utterance from the user; and
testing, by the generative artificial intelligence model using the natural language utterance, functionality of the agent to implement the purpose of the agent,
wherein configuring the agent is performed by the generative artificial intelligence model.

10. The system of claim 9, wherein the testing is an interactive process between the user and the generative artificial intelligence model, the interactive process comprising:
(i) evaluating the natural language utterance based on the specification document;
(ii) selecting the agent for use in responding to the natural language utterance based on evaluating the natural language utterance;
(iii) generating an execution plan comprising the one or more actions defined for the agent;
(iv) executing, based on the execution plan and the configuration information for the one or more assets, the one or more actions to obtain output data;
(v) generating a response to the natural language utterance based on the output data; and
(vi) evaluating, based on the response, the functionality of the agent to implement the purpose of the agent.

11. The system of claim 10, wherein the interactive process further comprises:
(vii) determining, based on evaluating the purpose of the agent, the functionality of the agent to implement the purpose of the agent is unacceptable;
(viii) in response to determining the functionality is unacceptable, receiving additional natural language input from the user concerning a change to the specification parameters;
(ix) reconfiguring the agent based on the change to the specification parameters; and
(x) reperforming steps (i)-(vi) of the interactive process.

12. The system of claim 8, wherein the defining the configuration information for the one or more assets comprises:
accessing a specification for each of the one or more assets;
extracting the configuration information from the specification for each of the one or more assets; and
writing the configuration information into the container.

13. The system of claim 8, wherein the operations further comprise:
receiving a natural language utterance as a user input to the digital assistant; and
generating a response to the natural language utterance based on the specification document and the agent.

14. The system of claim 13, wherein the generating the response comprises:
executing, using the natural language utterance, a search on specification documents in the data store, wherein the specification documents include the specification document for the agent;
identifying, based on the search, one or more candidate agents and associated actions for generating the response, wherein the one or more candidate agents include the agent;
generating an input prompt by combining metadata obtained from specification documents for the one or more candidate agents with the natural language utterance, wherein the metadata comprises the metadata written in the specification document for the agent;
generating, by a first generative artificial intelligence model and based on the input prompt, an execution plan for responding to the natural language utterance, wherein the execution plan includes an order list of actions comprising the one or more actions;
executing, based on the execution plan and the configuration information for the one or more assets, the one or more actions to obtain output data;
generating, using the output data, an output prompt for a second generative artificial intelligence model of the digital assistant, the second generative artificial intelligence model being the same or different from the first generative artificial intelligence model; and
generating, by the second generative artificial intelligence model and based on the output prompt, the response to the natural language utterance.

15. One or more non-transitory computer-readable media storing instructions which, when executed by one or more processors, cause a system to perform operations comprising:
accessing a container defining an agent configurable to have one or more actions;
configuring the agent for use by a digital assistant, wherein the configuring comprises:
defining, based on natural language input from a user, specification parameters including an identification of the agent, a purpose of the agent, and identification of one or more assets for implementing the purpose,
defining configuration information for the one or more assets, and
defining the one or more actions based on the configuration information, the natural language input from the user, or both;
generating a specification document that characterizes the agent, wherein generating the specification document comprises: acquiring, from the agent, metadata associated with: the specification parameters, the one or more assets, the one or more actions, or any combination thereof, and writing the specification document to include the metadata and the identification of the agent; and
storing the specification document in a data store that is communicatively coupled to the digital assistant.

16. The one or more non-transitory computer-readable media of claim 15, wherein the operations further comprise:
receiving, by a generative artificial intelligence model, a natural language utterance from the user; and
testing, by the generative artificial intelligence model using the natural language utterance, functionality of the agent to implement the purpose of the agent,
wherein configuring the agent is performed by the generative artificial intelligence model.

17. The one or more non-transitory computer-readable media of claim 16, wherein the testing is an interactive process between the user and the generative artificial intelligence model, the interactive process comprising:
(i) evaluating the natural language utterance based on the specification document;
(ii) selecting the agent for use in responding to the natural language utterance based on evaluating the natural language utterance;
(iii) generating an execution plan comprising the one or more actions defined for the agent;
(iv) executing, based on the execution plan and the configuration information for the one or more assets, the one or more actions to obtain output data;
(v) generating a response to the natural language utterance based on the output data;
(vi) evaluating, based on the response, the functionality of the agent to implement the purpose of the agent;
(vii) determining, based on evaluating the purpose of the agent, the functionality of the agent to implement the purpose of the agent is unacceptable;
(viii) in response to determining the functionality is unacceptable, receiving additional natural language input from the user concerning a change to the specification parameters;
(ix) reconfiguring the agent based on the change to the specification parameters; and
(x) reperforming steps (i)-(vi) of the interactive process.

18. The one or more non-transitory computer-readable media of claim 16, wherein the defining the configuration information for the one or more assets comprises:
accessing a specification for each of the one or more assets;
extracting the configuration information from the specification for each of the one or more assets; and
writing the configuration information into the container.

19. The one or more non-transitory computer-readable media of claim 16, wherein the operations further comprise:
receiving a natural language utterance as a user input to the digital assistant; and
generating a response to the natural language utterance based on the specification document and the agent.

20. The one or more non-transitory computer-readable media of claim 19, wherein the generating the response comprises:
executing, using the natural language utterance, a search on specification documents in the data store, wherein the specification documents include the specification document for the agent;
identifying, based on the search, one or more candidate agents and associated actions for generating the response, wherein the one or more candidate agents include the agent;
generating an input prompt by combining metadata obtained from specification documents for the one or more candidate agents with the natural language utterance, wherein the metadata comprises the metadata written in the specification document for the agent;
generating, by a first generative artificial intelligence model and based on the input prompt, an execution plan for responding to the natural language utterance, wherein the execution plan includes an order list of actions comprising the one or more actions;
executing, based on the execution plan and the configuration information for the one or more assets, the one or more actions to obtain output data;
generating, using the output data, an output prompt for a second generative artificial intelligence model of the digital assistant, the second generative artificial intelligence model being the same or different from the first generative artificial intelligence model; and
generating, by the second generative artificial intelligence model and based on the output prompt, the response to the natural language utterance.
